(19) United States
(12) Patent Application Publication
(10) Pub. No.: US 2010/0217605 A1
(43) Pub. Date: Aug. 26, 2010

(54) METHODS AND DEVICES FOR PERFORMING A FAST MODIFIED DISCRETE COSINE TRANSFORM OF AN INPUT SEQUENCE

(75) Inventors: Guixing Wu, Waterloo (CA); En-Hui Yang, Waterloo (CA)

Correspondence Address: Ridout & Maybee LLP, 225 King Street West, 10th Floor, Toronto, ON, M5V 3M2, CA

(73) Assignee: RESEARCH IN MOTION LIMITED

(21) Appl. No.: 12/393,104

(22) Filed: Feb. 26, 2009

(51) Int. Cl. G10L 19/00

(52) U.S. Cl. 704/500; 704/E19.001

(57) ABSTRACT

An improved fast N-point MDCT process and encoder/decoder is disclosed. The N-point MDCT may be realized through an N/2-point DCT algorithm. The N/2 DCT transform matrix is directly factored and the factored DCT transform matrices are used to develop a set of equations for realizing the N-point MDCT coefficients from an input sequence. The factoring of the DCT transform matrix may include expressing the DCT transform as a multiplication of matrices and exploiting mirror images within the matrices. It may further include simplifying at least one of the matrices by eliminating a variable based on trigonometric identity

### FIELD

The present application relates to methods and systems for performing a fast modified discrete cosine transform of an input sequence and, in particular, to encoders and decoders implementing audio encoding and decoding.

### BACKGROUND

Audio compression/encoding standards often employ a modified discrete cosine transform (MDCT) to obtain spectral coefficients from an input audio sequence. To improve the speed of the compression/encoding process, many have tried to develop fast MDCT processes. For example, some authors have proposed converting an N-point MDCT into N/4-point discrete cosine transform (DCT) and N/4-point discrete sine transform (DST): see V. Britanak and K. R. Rao, “An efficient implementation of the forward and inverse MDCT in MPEG Audio Coding”, IEEE Signal Processing Letters, Vol. 8, No. 2, pp. 48-51, February 2001; and V. Britanak and K. R. Rao, “A new fast algorithm for the unified forward and inverse MDCT/MDST computation”, Signal Processing Letters, Vol. 82, pp. 433-459, 2002.

In another example, one other has proposed a method in which an N-point MDCT is converted to two identical N/4-point DCTs: S.-W. Lee, “Improved algorithm for efficient computation of the forward and backward MDCT in MPEG audio coder”, IEEE Transactions on Circuits and Systems-II: Analog and Digital Signal Processing, Vol. 48, No. 10, pp. 990-994, October 2001.

It would be advantageous to provide an improved process for performing N-point MDCT and its inverse and an encoder and decoder implementing such a process. It would be advantageous to provide an improved MDCT or its inverse that realizes the transform using fewer multiplications and/or additions than existing transform processes.

### BRIEF DESCRIPTION OF THE DRAWINGS

Reference will now be made, by way of example, to the accompanying drawings which show example embodiments of the present application, and in which:

FIG. 1 shows an audio encoding process to which example embodiments may be applied;

FIG. 2 shows, in flowchart form, an example method of encoding an audio input sample in accordance with the present application; and

FIG. 3 shows, in flowchart form, an example process for generating the set of equations used in the process shown in FIG. 2; and

FIG. 4 shows, in block diagram form, an example embodiment of an encoder.

Similar reference numerals may have been used in different figures to denote similar components.

### DESCRIPTION OF EXAMPLE EMBODIMENTS

The present application provides an N-point MDCT process and encoder by directly factoring the N/2 DCT transform matrix, and using the factored DCT transform matrix to develop the set of equations for realizing the N-point MDCT coefficients from an input sequence. The factoring of the DCT transform matrix may include expressing the DCT transform as a multiplication of matrices and exploiting mirror images within the matrices. It may further include simplifying at least one of the matrices by eliminating a variable based on trigonometric identity.

In one aspect, the present application describes a method of encoding an audio signal using a modified discrete cosine transform (MDCT). The method includes receiving the audio signal, the audio signal including an input sequence of length N; calculating a scaled interim sequence as a function of the input sequence; calculating an output sequence of discrete cosine transform (DCT) coefficients by performing an N/2-point DCT of the scaled interim sequence by applying to the scaled interim sequence a set of equations derived by factoring a DCT transform matrix into a multiplication of at least three matrices and performing at least one simplifying operation; calculating the MDCT coefficients of the input sequence from the DCT coefficients; and encoding the MDCT coefficients.

In some embodiments, the factoring of the DCT transform matrix and/or the simplifying operations may rely on mirror images within the matrices and Gaussian elimination. In some embodiments, the factoring and/or simplifying may rely on applying trigonometric identities to eliminate one or more variables from factored matrices. Other mathematical simplifications to reduce or eliminate additions and/or multiplications in the application of the DCT transform may be realized through expressing the DCT transform matrix as a matrix multiplication and further factoring and/or simplifying the matrix expressions.

In another aspect, the present application describes an encoder for applying the set of equations obtained for implementing the fast MDCT to an audio input sequence. The encoder includes a processor and memory storing program instructions to configure the processor to apply the set of equations to an interim sequence derived from the input audio sequence to produce MDCT coefficients. The encoder may further include a quantization and entropy coding module for encoding the MDCT coefficients.

In another aspect, the present application describes a decoder for decoding the encoded MDCT coefficients.

In some embodiments the methods and/or encoder/decoder may be configured for input sequences of length N=12. In some embodiments the methods and/or encoder/decoder may be configured for input sequences of length N=36.

In another aspect, the present application discloses method of encoding an audio signal using a modified discrete cosine transform. The method includes receiving the audio signal, the audio signal including a data sequence; multiplying the data sequence by a windowing sequence to create a windowed data sequence of length N; calculating a scaled interim sequence of length N/2 as a function of the windowed data sequence; performing an N/2-point DCT of the scaled interim sequence to create an output sequence of DCT coefficients; calculating the MDCT coefficients of the data sequence from the DCT coefficients; and encoding the MDCT coefficients. Each element of the scaled interim sequence is a difference between two elements of the data sequence multiplied by an indexed coefficient. The indexed coefficient is incorporated into the window sequence and applied when multiplying the data sequence by the windowing sequence.

In yet another aspect, the present application discloses a computer program product including a computer-readable medium containing program instructions for configuring a computer processor to implement the above method.

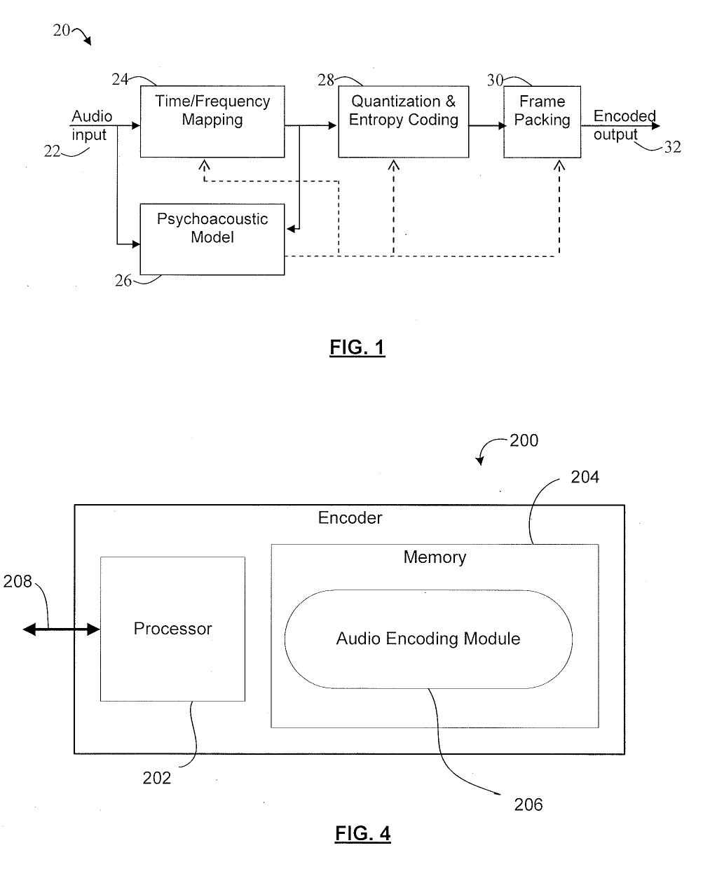

Reference is now made to FIG. 1, which shows an example MP3 encoding process 20 to which example embodiments may be applied. Generally, the MP3 encoding process 20 receives digital audio input 22 and produces a compressed or encoded output 32 in the form of a bitstream for storage and transmission. The encoding process 20 may for example be implemented by an encoder such as a suitably configured computing device. In FIG. 1, continuous lines denote the time or spectral domain signal flow, and dash lines denote the control information flow. As shown, the encoding process 20 includes audio input 22 for input to a time/frequency (T/F) mapping module 24 and a psychoacoustic model module 26. Also shown are a quantization and entropy coding module 28 and a frame packing module 30. The encoding process 20 results in an encoded output 32 of the audio input 22, for example for sending to a decoder for subsequent decoding.

The audio input 22 (in time domain) are first input into the T/F mapping module 24, which converts the audio input 22 into spectral coefficients. The T/F mapping module 24 is composed of three steps: pseudo-quadrature mirror filter (PQMF), windowing and modified discrete cosine transform (MDCT), and aliasing reduction. The PQMF filterbank splits a so-called granule (in MPEG I and II layer 3 each audio frame contains 2 and 1 granules respectively) of 576 input audio samples into 32 equally spaced subbands, where each subband has 18 time domain audio samples. The 18 time domain audio samples in each subband are then combined with their counterpart of the next frame, and processed by a sine-type window based on psychoacoustic modeling decisions. A long window, which covers a whole length of 36, addresses stationary audio parts. Long windowing with MDCT afterwards ensures a high frequency resolution, but also causes quantization errors spreading over the 1152 time-samples in the process of quantization. A short window is used to reduce the temporal noise to spread for the signals containing transients/attacks. In the short window, audio signals with a length of 36 are divided into 3 equal sub-blocks. In order to ensure a smooth transition from a long window to a short window and vice versa, two transition windows, long-short (start) and short-long (stop), which have the same size as a long window, are employed.

The psychoacoustic model module 26 is generally used to generate control information for the T/F mapping module 24, and for the quantization and entropy coding module 28. Based on the control information from the psychoacoustic model module 26, the spectral coefficients which are output from the T/F mapping module 24 are received by the quantization and entropy coding module 28, and are quantized and entropy coded. Finally these compressed bits streams are packed up along with format information, control information and other auxiliary data in MP3 frames, and output as the encoded output 32.

As noted above, long windowing results in a sequence of 36 audio samples. Short windowing results in a sequence of 12 audio samples. Accordingly, MP3 encoding involves performing 12-point MDCTs and 36-point MDCTs. The speed of the encoding process will partly depend on the ability to perform these transformations reasonably quickly. In other applications, the fast implementation of MDCT is often realized using complex-valued fast Fourier transform (FFT). However, because FFT requires the data length of the input sequence to be 2^{m} (m is an integer), it is not suitable for MP3 encoding. As a result it can be inefficient to calculate 12-point and 36-point MDCTs in MP3 audio coding. As noted above, more efficient MDCT algorithms have recently been proposed by employing fast discrete cosine transform (DCT) and discrete sine transform (DST). The present application presents an improved method for performing the MDCT process.

In this application, an N-point MDCT is converted into N/2-point DCT. A similar process is proposed in S,.-W. Lee, “Improved algorithm for efficient computation of the forward and backward MDCT in MPEG audio coder”, IEEE Transactions on Circuits and Systems-II: Analog and Digital Signal Processing, Vol. 48, No. 10, pp. 990-994, October 2001. However, in the present application the N/2-point DCT matrix is then directly factored. The factoring may use Gaussian elimination and trigonometric identities. Experimental testing of the resulting algorithm shows it to be more computationally efficient than the algorithms developed in the literature thus far. Furthermore, in some embodiments, the multiplications in the process of converting MDCT into DCT can be merged into the windowing step in MP3 coding, which further reduces the computational complexity.

The present application first describes the development of the fast MDCT, including the definition of the various matrices for realizing the MDCT Xₖ of input sequence xₘ. Example embodiments of the fast MDCT are then described for 12-point and 36-point sequences, including the factorization of the DCT transform matrices, to realize the set of equations in each case for obtaining the DCT coefficients Yₖ from which the MDCT coefficients Xₖ are easily obtained.

As a starting point, the forward MDCT can be represented by the following expression:

$${X}_{k} = {\sum }_{m = 0}^{N - 1} {x}_{m} \cdot cos [ \frac{π}{2 N} ( 2 k + 1 ) ( 2 m + 1 + \frac{N}{2} ) ] , \\ k = 0 , 1 , … , \frac{N}{2} - 1 , \qquad ( 1 )$$

where xₘ is an audio input sequence of length N, and m=0, . . . , N−1.

Reordering the input sequence xₘ, results in a reordered input sequence yₘ with the following properties:

$${y}_{m} = \{ \begin{matrix}- {x}_{m + ( 3 N / 4 ) , m = 0 , 1 , … , \frac{N}{4} - 1} \\ {x}_{m - ( N / 4 ) , m = \frac{N}{4} , \frac{N}{4} + 1 , … N - 1}\end{matrix} \qquad ( 2 )$$

Reordering of the input sequence xₘ is useful for the purpose of the following description, but is not necessarily done in practical implementations.

Using the reordered input sequence yₘ, the forward MDCT can be rewritten as:

$${X}_{k} = {\sum }_{m = 0}^{N - 1} {y}_{m} \cdot cos [ \frac{π}{2 N} ( 2 k + 1 ) ( 2 m + 1 ) ] , \\ k = 0 , 1 , … \frac{N}{2} - 1. \qquad ( 3 )$$

Equation (3) can be further rewritten to define the MDCT coefficients Xₖ as follows:

$${X}_{k} = {\sum }_{m = 0}^{N / 2 - 1} ( {y}_{m} - {y}_{N - 1 - m} ) cos [ \frac{π}{2 N} ( 2 k + 1 ) ( 2 m + 1 ) ] \qquad ( 4 )$$

Equation (4) defines the MDCT coefficients Xₖ as a function of the reordered input sequence yₘ. Below we define an interim sequence wₘ of length N/2, which incorporates the term (yₘ−y_{N-1-m}) from equation (4). This permits us to define an N/2-point DCT Yₖ of the reordered input sequence as a function of the interim sequence wₘ. From the coefficients of the N/2-point DCT Yₖ we can easily obtain the coefficients of the MDCT Xₖ.

The N/2-point DCT of the interim sequence wₘ is defined as follows:

$${Y}_{k} = {\sum }_{m = 0}^{N / 2 - 1} {w}_{m} cos [ \frac{π}{N} k ( 2 m + 1 ) ] , \\ k = 0 , 1 , … \frac{N}{2} - 1 \qquad ( 5 )$$

The interim sequence wₘ is defined by the following expression:

$${w}_{m} = ( {y}_{m} - {y}_{N - 1 - m} ) \frac{1}{2 cos ( \frac{π}{N} \frac{2 m + 1}{2} )} \qquad ( 6 )$$

In Equation (6), it will be understood that the index m ranges from 0 to N/2−1. Based on the foregoing definitions it can be shown that:

Xₖ=Yₖ+Yₖ₊₁, k=0,1, . . . , N/2−1. (7)

It will be noted that Y_{N/2}=0.

Those skilled in the art will appreciate from the foregoing description that Yₖ is the N/2-point DCT of wₘ. Accordingly, the N-point MDCT transform is realized by resorting to N/2-point DCT. In addition, the MDCT requires N/2 multiplications in Equation (6) and (N/2)-1 additions in Equation (7). Instead of decomposing the N/2-point DCT into a pair of N/4-point DCT, the N/2-point DCT matrix may be factored to reduce the number of multiplications and additions required to realize the MDCT, as will be described in greater detail below.

Again, it will be appreciated that in many implementations the interim sequence wₘ may be directly calculated from the input sequence xₘ without performing a reordering operation. In some sense, the reordering is conceptual and is incorporated into the definition and calculation of wₘ from the input sequence xₘ.

Before factoring the DCT transform matrix, it may be helpful in some embodiments to apply some preliminary scaling to avoid unnecessary multiplications. For example, we may redefine the interim sequence wₘ as follows:

$${w}_{m} = ( {y}_{m} - {y}_{N - 1 - m} ) \frac{1}{2 \sqrt{2} cos ( \frac{π}{N} \frac{2 m + 1}{2} )} \qquad ( 8 )$$

In Equation (8) above, the interim sequence wₘ has been scaled by a factor of 1/\sqrt{2}. Accordingly, to compensate in the expression for the DCT coefficients Yₖ given by Equation (5), the expression may be descaled by a factor of \sqrt{2}, which gives:

$${Y}_{k} = {\sum }_{m = 0}^{N / 2 - 1} {w}_{m} \sqrt{2} cos [ \frac{π}{N} k ( 2 m + 1 ) ] \qquad ( 9 )$$

In the example embodiments described below, the scaling and descaling may have a particular benefit in reducing the number of multiplications in 36-point MDCT.

### 12-Point MDCT

The 12-point MDCT can be converted into 6-point DCT using Equations (7), (8), and (9). The resulting relationship for the 6-point DCT coefficients can be expressed in matrix form as Yₖ=D·wₘ, where k=0,1, . . . ,5 and m=0,1, . . . ,5.

Illustrated in expanded matrix form for N=6, Equation (7) provides:

$$[ \begin{matrix}{Y}_{0} \\ {Y}_{1} \\ {Y}_{2} \\ {Y}_{3} \\ {Y}_{4} \\ {Y}_{5}\end{matrix} ] = [ \begin{matrix}{d}_{0} & {d}_{0} & {d}_{0} & {d}_{0} & {d}_{0} & {d}_{0} \\ {d}_{1} & {d}_{3} & {d}_{5} & - {d}_{5} & - {d}_{3} & - {d}_{1} \\ {d}_{2} & 0 & - {d}_{2} & - {d}_{2} & 0 & {d}_{2} \\ {d}_{3} & - {d}_{3} & - {d}_{3} & {d}_{3} & {d}_{3} & - {d}_{3} \\ {d}_{4} & - 2 {d}_{4} & {d}_{4} & {d}_{4} & - 2 {d}_{4} & {d}_{4} \\ {d}_{5} & - {d}_{3} & {d}_{1} & - {d}_{1} & {d}_{3} & - {d}_{5}\end{matrix} ] \cdot [ \begin{matrix}{w}_{0} \\ {w}_{1} \\ {w}_{2} \\ {w}_{3} \\ {w}_{4} \\ {w}_{5}\end{matrix} ] \\ where {d}_{k} = \sqrt{2} cos ( \frac{k}{12} π ) . \qquad ( 10 )$$

Note that if the DCT transform matrix D is divided in half vertically, the left half of each row is either a mirror image of the right or a negative mirror image. The DCT transform matrix D may be factored to group the mirror image rows together and the negative mirror image rows together to produce the following expression of the DCT transform matrix as a multiplication of matrices:

$$D = [ \begin{matrix}1 & 0 & 0 & 0 & 0 & 0 \\ 0 & 0 & 0 & 1 & 0 & 0 \\ 0 & 1 & 0 & 0 & 0 & 0 \\ 0 & 0 & 0 & 0 & 1 & 0 \\ 0 & 0 & 1 & 0 & 0 & 0 \\ 0 & 0 & 0 & 0 & 0 & 1\end{matrix} ] [ \begin{matrix}\sqrt{2} & \sqrt{2} & \sqrt{2} & \sqrt{2} & \sqrt{2} & \sqrt{2} \\ {d}_{2} & 0 & - {d}_{2} & - {d}_{2} & 0 & {d}_{2} \\ {d}_{4} & - 2 {d}_{4} & {d}_{4} & {d}_{4} & - 2 {d}_{4} & {d}_{4} \\ {d}_{1} & 1 & {d}_{5} & - {d}_{5} & - 1 & - {d}_{1} \\ 1 & - 1 & - 1 & 1 & 1 & - 1 \\ {d}_{5} & - 1 & {d}_{1} & - {d}_{1} & 1 & - {d}_{5}\end{matrix} ] \qquad ( 11 )$$

It will be noted that the upper left quarter of the rightmost matrix in Equation (11) is a mirror image of the upper right quarter. Similarly, the lower left quarter of the rightmost matrix in Equation (11) is a negative mirror image of the lower right quarter. The mirror imaging can be factored out to produce the following expression of DCT transform matrix D:

$$D = [ \begin{matrix}1 & 0 & 0 & 0 & 0 & 0 \\ 0 & 0 & 0 & 1 & 0 & 0 \\ 0 & 1 & 0 & 0 & 0 & 0 \\ 0 & 0 & 0 & 0 & 1 & 0 \\ 0 & 0 & 1 & 0 & 0 & 0 \\ 0 & 0 & 0 & 0 & 0 & 1\end{matrix} ] [ \begin{matrix}\sqrt{2} & \sqrt{2} & \sqrt{2} & 0 & 0 & 0 \\ {d}_{2} & 0 & - {d}_{2} & 0 & 0 & 0 \\ {d}_{4} & - 2 {d}_{4} & {d}_{4} & 0 & 0 & 0 \\ 0 & 0 & 0 & {d}_{5} & 1 & {d}_{1} \\ 0 & 0 & 0 & - 1 & - 1 & 1 \\ 0 & 0 & 0 & {d}_{1} & - 1 & {d}_{5}\end{matrix} ] [ \begin{matrix}1 & 0 & 0 & 0 & 0 & 1 \\ 0 & 1 & 0 & 0 & 1 & 0 \\ 0 & 0 & 1 & 1 & 0 & 0 \\ 0 & 0 & 1 & - 1 & 0 & 0 \\ 0 & 1 & 0 & 0 & - 1 & 0 \\ 1 & 0 & 0 & 0 & 0 & - 1\end{matrix} ] \qquad ( 12 )$$

The 3×3 submatrix in the lower right corner of the second matrix of Equation (12) can be rewritten to extract the middle row and be expressed as the addition of two matrices:

$$[ \begin{matrix}{d}_{5} & 1 & {d}_{1} \\ - 1 & - 1 & 1 \\ {d}_{1} & - 1 & {d}_{5}\end{matrix} ] = [ \begin{matrix}{d}_{5} & 1 & {d}_{1} \\ 0 & 0 & 0 \\ {d}_{1} & - 1 & {d}_{5}\end{matrix} ] + [ \begin{matrix}0 & 0 & 0 \\ - 1 & - 1 & 1 \\ 0 & 0 & 0\end{matrix} ] \qquad ( 13 )$$

A trigonometric identity may be applied to simplify Equation (13). Recall that

$$cos ( \frac{π}{12} ) = cos ( \frac{π}{4} ) + cos ( \frac{5}{12} π ) .$$

It will be appreciated that, d₁=1+d₅, since

$${d}_{1} = \sqrt{2} cos ( \frac{1}{12} π ) and {d}_{5} = \sqrt{2} cos ( \frac{5}{12} π ) .$$

Using the trigonometric identity, the first matrix on the right hand of Equation (13) may be factored as:

$$[ \begin{matrix}{d}_{5} & 1 & {d}_{1} \\ 0 & 0 & 0 \\ {d}_{1} & - 1 & {d}_{5}\end{matrix} ] = [ \begin{matrix}1 & 1 & 0 \\ 0 & 0 & 0 \\ 1 & 0 & 1\end{matrix} ] [ \begin{matrix}{d}_{5} & 0 & 0 \\ 0 & 1 & 0 \\ 0 & 0 & 1\end{matrix} ] [ \begin{matrix}1 & 0 & 1 \\ 0 & 1 & 1 \\ 1 & - 1 & 0\end{matrix} ] \qquad ( 14 )$$

Having factored the DCT transform matrix D and performed the described simplifying operations to realize Equations (12), (13) and (14), we may now solve the matrix multiplications and perform certain simplifications to realize a set of equations for solving Equation (10) and obtaining the N/2-point DCT coefficients Yₖ.

First, taking the expression of DCT transform matrix D in Equation (12) and the interim sequence wₘ, we start with the rightmost matrix of Equation (12) and define the following variables:

a₀=w₀+w₅

a₅=w₀−w₅

a₁=w₁+w₄

a₄=w₁−w₄

a₂=w₂+w₃

a₃=w₂−w₃

The 3×3 matrix at the upper left corner of the middle matrix in Equation (12) results in the following expressions:

Y₂=d₂(a₀−a₂);

Y₀=d₀(a₀+a₂+a₁);

Y₄=d₄(a₀+a₂−a₁−a₁);

where d₀=\sqrt{2} and d₄=\sqrt{1/2}. Note that the term a₀+a₂ appears in two of the above expression. We may define an interim variable z₁=a₀+a₂ for easy of computation. Thus we get the following:

Y₀=\sqrt{2}(z₁+a₁);

Y₄=\sqrt{1/2}(z₁−a₁−a₁);

Turning now to Equation (14), we can solve the matrix multiplication computing from right to left. Beginning with the rightmost matrix, we obtain a₃+a₅; a₄+a₅; and a₃−a₄. From the second matrix of Equation (14), we get: d₅·(a₃+a₅); a₄+a₅; and a₃−a₄. Now proceeding to the leftmost matrix of Equation (14), we find the result of Equation (14) is:

d₅·(a₃+a₅)+(a₄+a₅);

0;

d₅·(a₃+a₅)+(a₃−a₄).

To save on computations, we define a second variable z₁ as z₁=d₅·(a₃+a₅). If we then turn to the lower right hand 3×3 submatrix of the middle matrix in Equation (12) as defined in Equation (13), we obtain the following expressions:

Y₃=a₅−a₄−a₃;

Y₁=z₁+a₄+a₅;

Y₅=z₁+a₃−a₄;

Accordingly, above is a set of equations defining the DCT coefficients Yₖ in terms of the interim sequence wₘ, which itself is defined in terms of the reordered input sequence yₘ, as set out in Equation (8). It will be appreciated that the trigonometric term within the definition of the interim sequence wₘ in Equation (8) may be precalculated and stored in a lookup table for the various values of m and N in some embodiments.

Advantageously, the above 6-point DCT requires 4 multiplications and 18 additions.

### 36-Point MDCT

The 36-point MDCT can be similarly converted into 18-point DCT using Equations (7), (8) and (9). The 18-point DCT transform matrix D may be expressed as:

$$[ \begin{matrix}{d}_{0} & {d}_{0} & {d}_{0} & {d}_{0} & {d}_{0} & {d}_{0} & {d}_{0} & {d}_{0} & {d}_{0} & {d}_{0} & {d}_{0} & {d}_{0} & {d}_{0} & {d}_{0} & {d}_{0} & {d}_{0} & {d}_{0} & {d}_{0} \\ {d}_{1} & {d}_{3} & {d}_{5} & {d}_{7} & {d}_{9} & {d}_{11} & {d}_{13} & {d}_{15} & {d}_{17} & - {d}_{17} & - {d}_{15} & - {d}_{13} & - {d}_{11} & - {d}_{9} & - {d}_{7} & - {d}_{5} & - {d}_{3} & - {d}_{1} \\ {d}_{2} & {d}_{6} & {d}_{10} & {d}_{14} & 0 & - {d}_{14} & - {d}_{10} & - {d}_{6} & - {d}_{2} & - {d}_{2} & - {d}_{6} & - {d}_{10} & - {d}_{14} & 0 & {d}_{14} & {d}_{10} & {d}_{6} & {d}_{2} \\ {d}_{3} & {d}_{9} & {d}_{15} & - {d}_{15} & - {d}_{9} & - {d}_{3} & - {d}_{3} & - {d}_{9} & - {d}_{15} & {d}_{15} & {d}_{9} & {d}_{3} & {d}_{3} & {d}_{9} & {d}_{15} & - {d}_{15} & - {d}_{9} & - {d}_{3} \\ {d}_{4} & {d}_{12} & - {d}_{16} & - {d}_{8} & - {d}_{0} & - {d}_{8} & - {d}_{16} & {d}_{12} & {d}_{4} & {d}_{4} & {d}_{12} & - {d}_{16} & - {d}_{8} & - {d}_{0} & - {d}_{8} & - {d}_{16} & {d}_{12} & {d}_{4} \\ {d}_{5} & {d}_{15} & - {d}_{11} & - {d}_{1} & - {d}_{9} & {d}_{17} & {d}_{7} & {d}_{3} & {d}_{13} & - {d}_{13} & - {d}_{3} & - {d}_{7} & - {d}_{17} & {d}_{9} & {d}_{1} & {d}_{11} & - {d}_{15} & - {d}_{5} \\ {d}_{6} & 0 & - {d}_{6} & - {d}_{6} & 0 & {d}_{6} & {d}_{6} & 0 & - {d}_{6} & - {d}_{6} & 0 & {d}_{6} & {d}_{6} & 0 & - {d}_{6} & - {d}_{6} & 0 & - {d}_{6} \\ {d}_{7} & - {d}_{15} & - {d}_{1} & - {d}_{13} & {d}_{9} & {d}_{5} & - {d}_{17} & - {d}_{3} & - {d}_{11} & {d}_{11} & {d}_{3} & {d}_{17} & - {d}_{5} & - {d}_{9} & {d}_{13} & {d}_{1} & {d}_{15} & - {d}_{7} \\ {d}_{8} & - {d}_{12} & - {d}_{4} & {d}_{16} & {d}_{0} & {d}_{16} & - {d}_{4} & - {d}_{12} & {d}_{8} & {d}_{8} & - {d}_{12} & - {d}_{4} & {d}_{16} & {d}_{0} & {d}_{16} & - {d}_{4} & - {d}_{12} & {d}_{8} \\ {d}_{9} & - {d}_{9} & - {d}_{9} & {d}_{9} & {d}_{9} & - {d}_{9} & - {d}_{9} & {d}_{9} & {d}_{9} & - {d}_{9} & - {d}_{9} & {d}_{9} & {d}_{9} & - {d}_{9} & - {d}_{9} & {d}_{9} & {d}_{9} & - {d}_{9} \\ {d}_{10} & - {d}_{6} & - {d}_{14} & {d}_{2} & 0 & - {d}_{2} & {d}_{14} & {d}_{6} & - {d}_{10} & - {d}_{10} & {d}_{6} & {d}_{14} & - {d}_{2} & 0 & {d}_{2} & - {d}_{14} & - {d}_{6} & {d}_{10} \\ {d}_{11} & - {d}_{3} & {d}_{17} & {d}_{5} & - {d}_{9} & - {d}_{13} & {d}_{1} & - {d}_{15} & - {d}_{7} & {d}_{7} & {d}_{15} & - {d}_{1} & {d}_{13} & {d}_{9} & - {d}_{5} & - {d}_{17} & {d}_{3} & - {d}_{11} \\ {d}_{12} & - 2 {d}_{12} & {d}_{12} & {d}_{12} & - 2 {d}_{12} & {d}_{12} & {d}_{12} & - 2 {d}_{12} & {d}_{12} & {d}_{12} & - 2 {d}_{12} & {d}_{12} & {d}_{12} & - 2 {d}_{12} & {d}_{12} & {d}_{12} & - 2 {d}_{12} & {d}_{12} \\ {d}_{13} & - {d}_{3} & {d}_{7} & - {d}_{17} & - {d}_{9} & {d}_{1} & - {d}_{11} & - {d}_{15} & {d}_{5} & - {d}_{5} & {d}_{15} & {d}_{11} & - {d}_{1} & - {d}_{1} & {d}_{17} & - {d}_{7} & {d}_{3} & - {d}_{13} \\ {d}_{14} & - {d}_{6} & {d}_{2} & - {d}_{10} & 0 & {d}_{10} & - {d}_{2} & {d}_{6} & - {d}_{14} & - {d}_{14} & {d}_{6} & - {d}_{2} & {d}_{10} & 0 & - {d}_{10} & {d}_{2} & - {d}_{6} & {d}_{14} \\ {d}_{15} & - {d}_{9} & {d}_{3} & - {d}_{3} & {d}_{9} & - {d}_{15} & - {d}_{15} & {d}_{9} & - {d}_{3} & {d}_{3} & - {d}_{9} & {d}_{15} & {d}_{15} & - {d}_{9} & {d}_{3} & - {d}_{3} & {d}_{9} & - {d}_{15} \\ {d}_{16} & - {d}_{12} & {d}_{8} & - {d}_{4} & {d}_{0} & - {d}_{4} & {d}_{8} & - {d}_{12} & {d}_{16} & {d}_{16} & - {d}_{12} & {d}_{8} & - {d}_{4} & {d}_{0} & - {d}_{4} & {d}_{8} & - {d}_{12} & {d}_{16} \\ {d}_{17} & - {d}_{15} & {d}_{13} & - {d}_{11} & {d}_{9} & - {d}_{7} & {d}_{5} & - {d}_{3} & {d}_{1} & - {d}_{1} & {d}_{3} & - {d}_{5} & {d}_{7} & - {d}_{9} & {d}_{11} & - {d}_{13} & {d}_{15} & - {d}_{17}\end{matrix} ]$$

$$where {d}_{k} = \sqrt{2} cos ( \frac{k}{36} π ) .$$

Following an approach similar to the one described above in connection with 12-point MDCT, the matrix D may be factored to give:

$$D = [ \begin{matrix}1 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 1 & 0 & 0 & 0 & 0 & 0 & 0 & 0 & 0 \\ 0 & 1 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 1 & 0 & 0 & 0 & 0 & 0 & 0 & 0 \\ 0 & 0 & 1 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 1 & 0 & 0 & 0 & 0 & 0 & 0 \\ 0 & 0 & 0 & 1 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 1 & 0 & 0 & 0 & 0 & 0 \\ 0 & 0 & 0 & 0 & 1 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 1 & 0 & 0 & 0 & 0 \\ 0 & 0 & 0 & 0 & 0 & 1 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 1 & 0 & 0 & 0 \\ 0 & 0 & 0 & 0 & 0 & 0 & 1 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 1 & 0 & 0 \\ 0 & 0 & 0 & 0 & 0 & 0 & 0 & 1 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 1 & 0 \\ 0 & 0 & 0 & 0 & 0 & 0 & 0 & 0 & 1 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 1\end{matrix} ] \times [ \begin{matrix}A & C \\ C & B\end{matrix} ] \times [ \begin{matrix}1 & 0 & 0 & 0 & 0 & 0 & 0 & 0 & 0 & 0 & 0 & 0 & 0 & 0 & 0 & 0 & 0 & 1 \\ 0 & 1 & 0 & 0 & 0 & 0 & 0 & 0 & 0 & 0 & 0 & 0 & 0 & 0 & 0 & 0 & 1 & 0 \\ 0 & 0 & 1 & 0 & 0 & 0 & 0 & 0 & 0 & 0 & 0 & 0 & 0 & 0 & 0 & 1 & 0 & 0 \\ 0 & 0 & 0 & 1 & 0 & 0 & 0 & 0 & 0 & 0 & 0 & 0 & 0 & 0 & 1 & 0 & 0 & 0 \\ 0 & 0 & 0 & 0 & 1 & 0 & 0 & 0 & 0 & 0 & 0 & 0 & 0 & 1 & 0 & 0 & 0 & 0 \\ 0 & 0 & 0 & 0 & 0 & 1 & 0 & 0 & 0 & 0 & 0 & 0 & 1 & 0 & 0 & 0 & 0 & 0 \\ 0 & 0 & 0 & 0 & 0 & 0 & 1 & 0 & 0 & 0 & 0 & 1 & 0 & 0 & 0 & 0 & 0 & 0 \\ 0 & 0 & 0 & 0 & 0 & 0 & 0 & 1 & 0 & 0 & 1 & 0 & 0 & 0 & 0 & 0 & 0 & 0 \\ 0 & 0 & 0 & 0 & 0 & 0 & 0 & 0 & 1 & 1 & 0 & 0 & 0 & 0 & 0 & 0 & 0 & 0 \\ 0 & 0 & 0 & 0 & 0 & 0 & 0 & 0 & 1 & - 1 & 0 & 0 & 0 & 0 & 0 & 0 & 0 & 0 \\ 0 & 0 & 0 & 0 & 0 & 0 & 0 & 1 & 0 & 0 & - 1 & 0 & 0 & 0 & 0 & 0 & 0 & 0 \\ 0 & 0 & 0 & 0 & 0 & 0 & 1 & 0 & 0 & 0 & 0 & - 1 & 0 & 0 & 0 & 0 & 0 & 0 \\ 0 & 0 & 0 & 0 & 0 & 1 & 0 & 0 & 0 & 0 & 0 & 0 & - 1 & 0 & 0 & 0 & 0 & 0 \\ 0 & 0 & 0 & 0 & 1 & 0 & 0 & 0 & 0 & 0 & 0 & 0 & 0 & - 1 & 0 & 0 & 0 & 0 \\ 0 & 0 & 0 & 1 & 0 & 0 & 0 & 0 & 0 & 0 & 0 & 0 & 0 & 0 & - 1 & 0 & 0 & 0 \\ 0 & 0 & 1 & 0 & 0 & 0 & 0 & 0 & 0 & 0 & 0 & 0 & 0 & 0 & 0 & - 1 & 0 & 0 \\ 0 & 1 & 0 & 0 & 0 & 0 & 0 & 0 & 0 & 0 & 0 & 0 & 0 & 0 & 0 & 0 & - 1 & 0 \\ 1 & 0 & 0 & 0 & 0 & 0 & 0 & 0 & 0 & 0 & 0 & 0 & 0 & 0 & 0 & 0 & 0 & - 1\end{matrix} ]$$

where the submatrices A and B are defined as follows:

$$\begin{matrix}A = [ \begin{matrix}{d}_{0} & {d}_{0} & {d}_{0} & {d}_{0} & {d}_{0} & {d}_{0} & {d}_{0} & {d}_{0} & {d}_{0} \\ {d}_{2} & {d}_{6} & {d}_{10} & {d}_{14} & 0 & - {d}_{14} & - {d}_{10} & - {d}_{6} & - {d}_{2} \\ {d}_{4} & {d}_{12} & - {d}_{16} & - {d}_{8} & - {d}_{0} & - {d}_{8} & - {d}_{16} & {d}_{12} & {d}_{4} \\ {d}_{6} & 0 & - {d}_{6} & - {d}_{6} & 0 & {d}_{6} & {d}_{6} & {d}_{6} & - {d}_{6} \\ {d}_{8} & - {d}_{12} & - {d}_{4} & {d}_{16} & 0 & {d}_{16} & - {d}_{4} & - {d}_{12} & {d}_{8} \\ {d}_{10} & - {d}_{6} & - {d}_{14} & {d}_{2} & 0 & - {d}_{2} & {d}_{14} & {d}_{6} & - {d}_{10} \\ {d}_{12} & - 2 {d}_{12} & {d}_{12} & {d}_{12} & - 2 {d}_{12} & {d}_{12} & {d}_{12} & - 2 {d}_{12} & {d}_{12} \\ {d}_{14} & - {d}_{6} & {d}_{2} & - {d}_{10} & 0 & {d}_{10} & - {d}_{2} & {d}_{6} & - {d}_{14} \\ {d}_{16} & - {d}_{12} & {d}_{8} & - {d}_{4} & {d}_{0} & - {d}_{4} & {d}_{8} & - {d}_{12} & {d}_{16}\end{matrix} ] , & ( 15 ) \\ B = [ \begin{matrix}{d}_{1} & {d}_{3} & {d}_{5} & {d}_{7} & {d}_{9} & {d}_{11} & {d}_{13} & {d}_{15} & {d}_{17} \\ {d}_{3} & {d}_{9} & {d}_{15} & - {d}_{15} & - {d}_{9} & - {d}_{3} & - {d}_{3} & - {d}_{9} & - {d}_{15} \\ {d}_{5} & {d}_{15} & - {d}_{11} & - {d}_{1} & - {d}_{9} & {d}_{17} & {d}_{7} & {d}_{3} & {d}_{13} \\ {d}_{7} & - {d}_{15} & - {d}_{1} & - {d}_{13} & {d}_{9} & {d}_{5} & - {d}_{17} & - {d}_{3} & - {d}_{11} \\ {d}_{9} & - {d}_{9} & - {d}_{9} & {d}_{9} & {d}_{9} & - {d}_{9} & - {d}_{9} & {d}_{9} & {d}_{9} \\ {d}_{11} & - {d}_{3} & {d}_{17} & {d}_{5} & - {d}_{9} & - {d}_{13} & {d}_{1} & - {d}_{15} & - {d}_{7} \\ {d}_{13} & - {d}_{3} & {d}_{7} & - {d}_{17} & - {d}_{9} & {d}_{1} & - {d}_{11} & - {d}_{15} & {d}_{5} \\ {d}_{15} & - {d}_{9} & {d}_{3} & - {d}_{3} & {d}_{9} & - {d}_{15} & - {d}_{15} & {d}_{9} & - {d}_{3} \\ {d}_{17} & - {d}_{15} & {d}_{13} & - {d}_{11} & {d}_{9} & - {d}_{7} & {d}_{5} & - {d}_{3} & {d}_{1}\end{matrix} ] , & ( 16 )\end{matrix}$$

and wherein C is a 9×9 matrix with all elements zero.

The 9×9 matrix A can be factored as

$$A = [ \begin{matrix}1 & 0 & 0 & 0 & 0 & 0 & 0 & 0 & 0 \\ 0 & 0 & 0 & 0 & 0 & 1 & 0 & 0 & 0 \\ 0 & 1 & 0 & 0 & 0 & 0 & 0 & 0 & 0 \\ 0 & 0 & 0 & 0 & 0 & 0 & 1 & 0 & 0 \\ 0 & 0 & 1 & 0 & 0 & 0 & 0 & 0 & 0 \\ 0 & 0 & 0 & 0 & 0 & 0 & 0 & 1 & 0 \\ 0 & 0 & 0 & 1 & 0 & 0 & 0 & 0 & 0 \\ 0 & 0 & 0 & 0 & 0 & 0 & 0 & 0 & 1 \\ 0 & 0 & 0 & 0 & 1 & 0 & 0 & 0 & 0\end{matrix} ] \times [ \begin{matrix}{d}_{0} & {d}_{0} & {d}_{0} & {d}_{0} & {d}_{0} & 0 & 0 & 0 & 0 \\ {d}_{4} & {d}_{12} & - {d}_{16} & - {d}_{8} & - {d}_{0} & 0 & 0 & 0 & 0 \\ {d}_{8} & - {d}_{12} & - {d}_{4} & - {d}_{16} & 0 & 0 & 0 & 0 & 0 \\ {d}_{12} & - 2 {d}_{12} & {d}_{12} & {d}_{12} & - 2 {d}_{12} & 0 & 0 & 0 & 0 \\ {d}_{16} & - {d}_{12} & {d}_{8} & - {d}_{4} & {d}_{0} & 0 & 0 & 0 & 0 \\ 0 & 0 & 0 & 0 & 0 & {d}_{14} & {d}_{10} & {d}_{6} & {d}_{2} \\ 0 & 0 & 0 & 0 & 0 & - {d}_{6} & - {d}_{6} & 0 & {d}_{6} \\ 0 & 0 & 0 & 0 & 0 & {d}_{2} & - {d}_{14} & - {d}_{6} & {d}_{10} \\ 0 & 0 & 0 & 0 & 0 & - {d}_{10} & {d}_{2} & - {d}_{6} & {d}_{14}\end{matrix} ] \times [ \begin{matrix}1 & 0 & 0 & 0 & 0 & 0 & 0 & 0 & 1 \\ 0 & 1 & 0 & 0 & 0 & 0 & 0 & 1 & 0 \\ 0 & 0 & 1 & 0 & 0 & 0 & 1 & 0 & 0 \\ 0 & 0 & 0 & 1 & 0 & 1 & 0 & 0 & 0 \\ 0 & 0 & 0 & 0 & 1 & 0 & 0 & 0 & 0 \\ 0 & 0 & 0 & 1 & 0 & - 1 & 0 & 0 & 0 \\ 0 & 0 & 1 & 0 & 0 & 0 & - 1 & 0 & 0 \\ 0 & 1 & 0 & 0 & 0 & 0 & 0 & - 1 & 0 \\ 1 & 0 & 0 & 0 & 0 & 0 & 0 & 0 & - 1\end{matrix} ] \qquad ( 17 )$$

It will be appreciated that the 5×5 submatrix in the top left corner of the second matrix on the right hand of Equation (17) can be converted into the following expression:

$$[ \begin{matrix}{d}_{0} & {d}_{0} & {d}_{0} & {d}_{0} & {d}_{0} \\ {d}_{4} & {d}_{12} & - {d}_{16} & - {d}_{8} & - {d}_{0} \\ {d}_{8} & - {d}_{12} & - {d}_{4} & - {d}_{16} & 0 \\ {d}_{12} & - 2 {d}_{12} & {d}_{12} & {d}_{12} & - 2 {d}_{12} \\ {d}_{16} & - {d}_{12} & {d}_{8} & - {d}_{4} & {d}_{0}\end{matrix} ] = [ \begin{matrix}1 & 0 & 0 & 0 & 0 \\ 0 & 0 & 0 & 1 & 0 \\ 0 & 1 & 0 & 0 & 0 \\ 0 & 0 & 1 & 0 & 0 \\ 0 & 0 & 0 & 0 & 1\end{matrix} ] \times [ \begin{matrix}{d}_{0} & {d}_{0} & {d}_{0} & {d}_{0} & {d}_{0} \\ {d}_{12} & {d}_{12} & {d}_{12} & - 2 {d}_{12} & - 2 {d}_{12} \\ {d}_{4} & - {d}_{16} & - {d}_{8} & {d}_{12} & - {d}_{0} \\ {d}_{8} & - {d}_{4} & - {d}_{16} & - {d}_{12} & 0 \\ {d}_{16} & {d}_{8} & {d}_{4} & - {d}_{12} & {d}_{0}\end{matrix} ] \times [ \begin{matrix}1 & 0 & 0 & 0 & 0 \\ 0 & 0 & 0 & 1 & 0 \\ 0 & 1 & 0 & 0 & 0 \\ 0 & 0 & 1 & 0 & 0 \\ 0 & 0 & 0 & 0 & 1\end{matrix} ] \qquad ( 18 )$$

Since d₄=d₈+d_{16,} the 3×3 submatrix in the lower left corner of the second matrix on the right hand of Equation (18) can be factored as:

$$[ \begin{matrix}{d}_{4} & - {d}_{16} & - {d}_{8} \\ {d}_{8} & - {d}_{4} & {d}_{16} \\ {d}_{16} & {d}_{8} & - {d}_{4}\end{matrix} ] = [ \begin{matrix}1 & 0 & 0 \\ 0 & 1 & 0 \\ 1 & - 1 & 0\end{matrix} ] [ \begin{matrix}1 & 1 & 0 \\ 1 & 0 & 1 \\ 0 & 0 & 0\end{matrix} ] [ \begin{matrix}{d}_{4} & 0 & 0 \\ 0 & {d}_{8} & 0 \\ 0 & 0 & {d}_{16}\end{matrix} ] [ \begin{matrix}1 & - 1 & 0 \\ 0 & 1 & - 1 \\ - 1 & 0 & 1\end{matrix} ] \qquad ( 19 )$$

Similarly, the 4×4 submatrix in the lower right corner of the second matrix on the right hand of Equation (7) can be factored into:

$$[ \begin{matrix}{d}_{14} & {d}_{10} & {d}_{6} & {d}_{2} \\ - {d}_{6} & - {d}_{6} & 0 & {d}_{6} \\ {d}_{2} & - {d}_{14} & - {d}_{6} & {d}_{10} \\ - {d}_{10} & {d}_{2} & - {d}_{6} & {d}_{14}\end{matrix} ] = [ \begin{matrix}1 & 0 & 0 & 0 \\ 0 & 0 & 1 & 0 \\ 0 & 0 & 0 & 1 \\ 0 & 1 & 0 & 0\end{matrix} ] [ \begin{matrix}{d}_{14} & {d}_{10} & {d}_{2} & {d}_{6} \\ {d}_{2} & - {d}_{14} & {d}_{10} & - {d}_{6} \\ - {d}_{10} & {d}_{2} & {d}_{14} & - {d}_{6} \\ - {d}_{6} & - {d}_{6} & {d}_{6} & 0\end{matrix} ] [ \begin{matrix}1 & 0 & 0 & 0 \\ 0 & 1 & 0 & 0 \\ 0 & 0 & 0 & 1 \\ 0 & 0 & 1 & 0\end{matrix} ] \qquad ( 20 )$$

Since d₂=d₁₀+d_{14,} the 3×3 submatrix in the top left corner of the second matrix on the right hand of Equation (20) can be factored as:

$$[ \begin{matrix}{d}_{14} & {d}_{10} & {d}_{2} \\ {d}_{2} & - {d}_{14} & {d}_{10} \\ - {d}_{10} & {d}_{2} & {d}_{14}\end{matrix} ] = [ \begin{matrix}1 & 0 & 0 \\ 0 & 1 & 0 \\ 1 & - 1 & 0\end{matrix} ] [ \begin{matrix}1 & 0 & 1 \\ 1 & - 1 & 0 \\ 0 & 0 & 0\end{matrix} ] [ \begin{matrix}{d}_{2} & 0 & 0 \\ 0 & {d}_{14} & 0 \\ 0 & 0 & {d}_{10}\end{matrix} ] [ \begin{matrix}1 & 0 & 1 \\ 0 & 1 & 1 \\ - 1 & 1 & 0\end{matrix} ] \qquad ( 22 )$$

Turning now to the matrix B defined in Equation 16, it can be factored into:

$$\begin{matrix}B = [ \begin{matrix}1 & 0 & 0 & 0 & 0 & 0 & 0 & 0 & 0 \\ 0 & 0 & 0 & 0 & 0 & 0 & 0 & 1 & 0 \\ 0 & 1 & 0 & 0 & 0 & 0 & 0 & 0 & 0 \\ 0 & 0 & 1 & 0 & 0 & 0 & 0 & 0 & 0 \\ 0 & 0 & 0 & 0 & 0 & 0 & 0 & 1 & 0 \\ 0 & 0 & 0 & 1 & 0 & 0 & 0 & 0 & 0 \\ 0 & 0 & 0 & 0 & 1 & 0 & 0 & 0 & 0 \\ 0 & 0 & 0 & 0 & 0 & 0 & 0 & 0 & 1 \\ 0 & 0 & 0 & 0 & 0 & 1 & 0 & 0 & 0\end{matrix} ] [ \begin{matrix}{B}_{1} \\ {B}_{2}\end{matrix} ] \\ where & ( 23 ) \\ {B}_{1} = [ \begin{matrix}{d}_{1} & {d}_{3} & {d}_{5} & {d}_{7} & {d}_{9} & {d}_{11} & {d}_{13} & {d}_{15} & {d}_{17} \\ {d}_{5} & {d}_{15} & - {d}_{11} & - {d}_{1} & - {d}_{9} & {d}_{17} & {d}_{7} & {d}_{3} & {d}_{13} \\ {d}_{7} & - {d}_{15} & - {d}_{1} & - {d}_{13} & {d}_{9} & {d}_{5} & - {d}_{17} & - {d}_{3} & - {d}_{11} \\ {d}_{11} & - {d}_{3} & {d}_{17} & {d}_{5} & - {d}_{9} & - {d}_{13} & {d}_{1} & - {d}_{15} & - {d}_{7} \\ {d}_{13} & - {d}_{3} & {d}_{7} & - {d}_{17} & - {d}_{9} & {d}_{1} & - {d}_{11} & - {d}_{15} & {d}_{5} \\ {d}_{17} & - {d}_{15} & {d}_{13} & - {d}_{11} & {d}_{9} & - {d}_{7} & {d}_{5} & - {d}_{3} & {d}_{1}\end{matrix} ] & ( 24 ) \\ {B}_{2} = [ \begin{matrix}{d}_{3} & {d}_{9} & {d}_{15} & - {d}_{15} & - {d}_{9} & - {d}_{3} & - {d}_{3} & - {d}_{9} & - {d}_{15} \\ {d}_{9} & - {d}_{9} & - {d}_{9} & {d}_{9} & {d}_{9} & - {d}_{9} & - {d}_{9} & {d}_{9} & {d}_{9} \\ {d}_{15} & - {d}_{9} & {d}_{3} & - {d}_{3} & {d}_{9} & - {d}_{15} & - {d}_{15} & {d}_{9} & - {d}_{3}\end{matrix} ] & ( 25 )\end{matrix}$$

The matrix B₁ can be further factored into:

$${B}_{1} = [ \begin{matrix}{d}_{1} & {d}_{5} & {d}_{7} & {d}_{11} & {d}_{13} & {d}_{17} & {d}_{3} & {d}_{9} & {d}_{15} \\ {d}_{5} & - {d}_{11} & - {d}_{1} & {d}_{17} & {d}_{7} & {d}_{13} & {d}_{15} & - {d}_{9} & {d}_{3} \\ {d}_{7} & - {d}_{1} & - {d}_{13} & {d}_{5} & - {d}_{17} & - {d}_{11} & - {d}_{15} & {d}_{9} & - {d}_{3} \\ {d}_{11} & {d}_{17} & {d}_{5} & - {d}_{13} & {d}_{1} & - {d}_{7} & - {d}_{3} & - {d}_{9} & - {d}_{15} \\ {d}_{13} & {d}_{7} & - {d}_{17} & {d}_{1} & - {d}_{11} & {d}_{5} & - {d}_{3} & - {d}_{9} & - {d}_{15} \\ {d}_{17} & {d}_{13} & - {d}_{11} & - {d}_{7} & {d}_{5} & {d}_{1} & - {d}_{15} & {d}_{9} & - {d}_{3}\end{matrix} ] \times [ \begin{matrix}1 & 0 & 0 & 0 & 0 & 0 & 0 & 0 & 0 \\ 0 & 0 & 1 & 0 & 0 & 0 & 0 & 0 & 0 \\ 0 & 0 & 0 & 1 & 0 & 0 & 0 & 0 & 0 \\ 0 & 0 & 0 & 0 & 0 & 1 & 0 & 0 & 0 \\ 0 & 0 & 0 & 0 & 0 & 0 & 1 & 0 & 0 \\ 0 & 0 & 0 & 0 & 0 & 0 & 0 & 1 & 0 \\ 0 & 1 & 0 & 0 & 0 & 0 & 0 & 0 & 0 \\ 0 & 0 & 0 & 0 & 1 & 0 & 0 & 0 & 0 \\ 0 & 0 & 0 & 0 & 0 & 0 & 0 & 0 & 1\end{matrix} ] \qquad ( 26 )$$

Since d₃=d₉+d₁₅, the 6×3 submatrix at the right of the first matrix on the right hand of Equation (26) can be factored as:

$$[ \begin{matrix}{d}_{3} & {d}_{9} & {d}_{15} \\ {d}_{15} & - {d}_{9} & {d}_{3} \\ - {d}_{15} & {d}_{9} & - {d}_{3} \\ - {d}_{3} & - {d}_{9} & - {d}_{15} \\ - {d}_{3} & - {d}_{9} & - {d}_{15} \\ - {d}_{15} & {d}_{9} & - {d}_{3}\end{matrix} ] = [ \begin{matrix}1 & 1 & 0 \\ 0 & - 1 & 1 \\ 0 & 1 & - 1 \\ - 1 & - 1 & 0 \\ - 1 & - 1 & 0 \\ 0 & 1 & - 1\end{matrix} ] + {d}_{15} \times [ \begin{matrix}1 & 0 & 1 \\ 1 & 0 & 1 \\ - 1 & 0 & - 1 \\ - 1 & 0 & - 1 \\ - 1 & 0 & - 1 \\ - 1 & 0 & - 1\end{matrix} ] \qquad ( 27 )$$

Turning first to the 6×6 submatrix at the left of the first matrix on the right hand of Equation (26),

$$M = [ \begin{matrix}{d}_{1} & {d}_{5} & {d}_{7} & {d}_{11} & {d}_{13} & {d}_{17} \\ {d}_{5} & - {d}_{11} & - {d}_{1} & {d}_{17} & {d}_{7} & {d}_{13} \\ {d}_{7} & - {d}_{1} & - {d}_{13} & {d}_{5} & - {d}_{17} & - {d}_{11} \\ {d}_{11} & {d}_{17} & {d}_{5} & - {d}_{13} & {d}_{1} & - {d}_{7} \\ {d}_{13} & {d}_{7} & - {d}_{17} & {d}_{1} & - {d}_{11} & {d}_{5} \\ {d}_{17} & {d}_{13} & - {d}_{11} & - {d}_{1} & {d}_{5} & {d}_{1}\end{matrix} ] \qquad ( 28 )$$

Trigonometric identities give us the following relationships:

$$\{ \begin{matrix}{d}_{1} = {d}_{11} + {d}_{13} \\ {d}_{5} = {d}_{7} + {d}_{17}\end{matrix} \qquad ( 29 )$$

Accordingly, the matrix M may be factored by factoring the four 3×3 submatrices of M respectively as in (19) and (20). After this factorization, there will be 12 multiplications remaining. However, in the following example embodiment, a different approach is adopted that will result in requiring only 6 multiplications after the factorization.

Using the following trigonometric identities:

$$\{ \begin{matrix}\sqrt{2} = 2 cos ( \frac{9}{36} π ) \\ 2 cos α cos β = cos ( α + β ) + cos ( α - β )\end{matrix} \qquad ( 30 )$$

the matrix M may be decomposed into:

$$M = [ \begin{matrix}{c}_{8} & {c}_{4} & {c}_{16} & - {c}_{16} & {c}_{4} & {c}_{8} \\ {c}_{4} & {c}_{16} & - {c}_{8} & {c}_{8} & {c}_{16} & {c}_{4} \\ {c}_{16} & - {c}_{8} & - {c}_{4} & {c}_{4} & - {c}_{8} & {c}_{16} \\ - {c}_{16} & {c}_{8} & {c}_{4} & - {c}_{4} & {c}_{8} & - {c}_{16} \\ {c}_{4} & {c}_{16} & - {c}_{8} & {c}_{8} & {c}_{16} & {c}_{4} \\ {c}_{8} & {c}_{4} & {c}_{16} & - {c}_{16} & {c}_{4} & {c}_{8}\end{matrix} ] + [ \begin{matrix}{c}_{10} & {c}_{14} & {c}_{2} & - {c}_{2} & - {c}_{14} & - {c}_{10} \\ {c}_{14} & - {c}_{2} & - {c}_{10} & - {c}_{10} & {c}_{2} & - {c}_{14} \\ {c}_{2} & - {c}_{10} & {c}_{14} & {c}_{14} & {c}_{10} & - {c}_{2} \\ {c}_{2} & - {c}_{10} & {c}_{14} & {c}_{14} & {c}_{10} & {c}_{2} \\ - {c}_{14} & {c}_{2} & {c}_{10} & {c}_{10} & - {c}_{2} & {c}_{14} \\ - {c}_{10} & - {c}_{14} & - {c}_{2} & - {c}_{2} & {c}_{14} & {c}_{10}\end{matrix} ] \\ wherein {c}_{k} = cos ( \frac{k}{36} π ) . \qquad ( 31 )$$

The first matrix on the right hand of Equation (31) may be factored as:

$$[ \begin{matrix}{c}_{10} & {c}_{14} & {c}_{2} & - {c}_{2} & - {c}_{14} & - {c}_{10} \\ {c}_{14} & - {c}_{2} & - {c}_{10} & - {c}_{10} & {c}_{2} & - {c}_{14} \\ {c}_{2} & - {c}_{10} & {c}_{14} & {c}_{14} & {c}_{10} & - {c}_{2} \\ {c}_{2} & - {c}_{10} & {c}_{14} & {c}_{14} & {c}_{10} & {c}_{2} \\ - {c}_{14} & {c}_{2} & {c}_{10} & {c}_{10} & - {c}_{2} & {c}_{14} \\ - {c}_{10} & - {c}_{14} & - {c}_{2} & - {c}_{2} & {c}_{14} & {c}_{10}\end{matrix} ] = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 1 & 0 & 0 & 0 \\ 0 & - 1 & 0 & 0 & 0 & 0 \\ - 1 & 0 & 0 & 0 & 0 & 0\end{matrix} ] \times [ \begin{matrix}{c}_{10} & {c}_{14} & {c}_{2} & {c}_{2} & - {c}_{14} & - {c}_{10} \\ {c}_{14} & - {c}_{2} & - {c}_{10} & - {c}_{10} & {c}_{2} & - {c}_{14} \\ {c}_{2} & - {c}_{10} & {c}_{14} & {c}_{14} & {c}_{10} & - {c}_{2} \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 32 )$$

and the second matrix on the right hand of Equation (32) may be further factored as:

$$[ \begin{matrix}{c}_{10} & {c}_{14} & {c}_{2} & {c}_{2} & - {c}_{14} & - {c}_{10} \\ {c}_{14} & - {c}_{2} & - {c}_{10} & - {c}_{10} & {c}_{2} & - {c}_{14} \\ {c}_{2} & - {c}_{10} & {c}_{14} & {c}_{14} & {c}_{10} & - {c}_{2} \\ 0 & 0 & 0 & 0 & 0 & 0 \\ 0 & 0 & 0 & 0 & 0 & 0 \\ 0 & 0 & 0 & 0 & 0 & 0\end{matrix} ] = [ \begin{matrix}1 & 0 & 1 & 0 & 0 & 0 \\ 0 & 1 & - 1 & 0 & 0 & 0 \\ 1 & 1 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \times [ \begin{matrix}{c}_{10} & 0 & 0 & 0 & 0 & 0 \\ 0 & {c}_{14} & 0 & 0 & 0 & 0 \\ 0 & 0 & {c}_{2} & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \times [ \begin{matrix}1 & - 1 & 0 & 0 & 0 & 0 \\ 1 & 0 & 1 & 0 & 0 & 0 \\ 0 & 1 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \times [ \begin{matrix}1 & 0 & 0 & 0 & 0 & - 1 \\ 0 & 1 & 0 & 0 & - 1 & 0 \\ 0 & 0 & 1 & 1 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 33 )$$

Similarly, the second matrix on the right hand of Equation (31) may be factored as:

$$[ \begin{matrix}{c}_{8} & {c}_{4} & {c}_{16} & - {c}_{16} & {c}_{4} & {c}_{8} \\ {c}_{4} & {c}_{16} & - {c}_{8} & {c}_{8} & {c}_{16} & {c}_{4} \\ {c}_{16} & - {c}_{8} & - {c}_{4} & {c}_{4} & - {c}_{8} & {c}_{16} \\ - {c}_{16} & {c}_{8} & {c}_{4} & - {c}_{4} & {c}_{8} & - {c}_{16} \\ {c}_{4} & {c}_{16} & - {c}_{8} & {c}_{8} & {c}_{16} & {c}_{4} \\ {c}_{8} & {c}_{4} & {c}_{16} & - {c}_{16} & {c}_{4} & {c}_{8}\end{matrix} ] = [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & - 1 & 0 & 0 & 0 \\ 0 & 1 & 0 & 0 & 0 & 0 \\ 1 & 0 & 0 & 0 & 0 & 0\end{matrix} ] [ \begin{matrix}{c}_{8} & {c}_{4} & {c}_{16} & - {c}_{16} & {c}_{4} & {c}_{8} \\ {c}_{4} & {c}_{16} & - {c}_{8} & {c}_{8} & {c}_{16} & {c}_{4} \\ {c}_{16} & - {c}_{8} & - {c}_{4} & {c}_{4} & - {c}_{8} & {c}_{16} \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 34 )$$

wherein the second matrix on the right hand of Equation (34) may be further factored as:

$$[ \begin{matrix}{c}_{8} & {c}_{4} & {c}_{16} & - {c}_{16} & {c}_{4} & {c}_{8} \\ {c}_{4} & {c}_{16} & - {c}_{8} & {c}_{8} & {c}_{16} & {c}_{4} \\ {c}_{16} & - {c}_{8} & - {c}_{4} & {c}_{4} & - {c}_{8} & {c}_{16} \\ 0 & 0 & 0 & 0 & 0 & 0 \\ 0 & 0 & 0 & 0 & 0 & 0 \\ 0 & 0 & 0 & 0 & 0 & 0\end{matrix} ] = [ \begin{matrix}1 & 1 & 0 & 0 & 0 & 0 \\ 1 & 0 & - 1 & 0 & 0 & 0 \\ 0 & - 1 & - 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \times [ \begin{matrix}{c}_{4} & 0 & 0 & 0 & 0 & 0 \\ 0 & {c}_{16} & 0 & 0 & 0 & 0 \\ 0 & 0 & {c}_{8} & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \times [ \begin{matrix}1 & 1 & 0 & 0 & 0 & 0 \\ - 1 & 0 & 1 & 0 & 0 & 0 \\ 0 & 1 & 1 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \times [ \begin{matrix}1 & 0 & 0 & 0 & 0 & 1 \\ 0 & 1 & 0 & 0 & 1 & 0 \\ 0 & 0 & 1 & - 1 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] \qquad ( 35 )$$

The matrix of B₂ from Equation (25) may be factored as:

$${B}_{2} = [ \begin{matrix}{d}_{3} & 1 & {d}_{15} & 0 & 0 & 0 & 0 & 0 & 0 \\ 1 & - 1 & - 1 & 0 & 0 & 0 & 0 & 0 & 0 \\ {d}_{15} & - 1 & {d}_{3} & 0 & 0 & 0 & 0 & 0 & 0\end{matrix} ] \times [ \begin{matrix}1 & 0 & 0 & 0 & 0 & - 1 & - 1 & 0 & 0 \\ 0 & 1 & 0 & 0 & - 1 & 0 & 0 & - 1 & 0 \\ 0 & 0 & 1 & - 1 & 0 & 0 & 0 & 0 & - 1 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0\end{matrix} ] \qquad ( 36 )$$

The 3×3 submatrix at the left of the first matrix on the right hand of Equation (36) can be converted into:

$$[ \begin{matrix}{d}_{3} & 1 & {d}_{15} \\ 1 & - 1 & - 1 \\ {d}_{15} & - 1 & {d}_{3}\end{matrix} ] = [ \begin{matrix}{d}_{3} & 1 & {d}_{15} \\ 0 & 0 & 0 \\ {d}_{15} & - 1 & {d}_{3}\end{matrix} ] + [ \begin{matrix}0 & 0 & 0 \\ 1 & - 1 & - 1 \\ 0 & 0 & 0\end{matrix} ] \qquad ( 37 )$$

Based on trigonometric identities, it is known that d₃=1+d₁₅, meaning that the first matrix on the right hand of Equation (37) can be factored as:

$$[ \begin{matrix}{d}_{3} & 1 & {d}_{15} \\ 0 & 0 & 0 \\ {d}_{15} & - 1 & {d}_{3}\end{matrix} ] = [ \begin{matrix}1 & 0 & 1 \\ 0 & 0 & 0 \\ 1 & 1 & 0\end{matrix} ] [ \begin{matrix}{d}_{15} & 0 & 0 \\ 0 & 1 & 0 \\ 0 & 0 & 1\end{matrix} ] [ \begin{matrix}1 & 0 & 1 \\ 0 & - 1 & 1 \\ 1 & 1 & 0\end{matrix} ] \qquad ( 38 )$$

Having factored the DCT transform matrix D and performed the described simplifying operations to realize Equations (15) through (38), we may now solve the matrix multiplications and perform certain simplifications to realize a set of equations for obtaining the 18-point DCT coefficients Yₖ.

Beginning with the rightmost matrix from the initial factorization of D the following interim variables can be defined:

a₀=w₀−w₁₇; b₀=w₀+w₁₇;

a₁=w₁−w₁₆; b₁=w₁+w₁₆;

a₂=w₂−w₁₅; b₂=w₂+w₁₅;

a₃=w₃−w₁₄; b₃=w₃+w₁₄;

a₄=w₄−w₁₃; b₄=w₄+w₁₃;

a₅=w₅−w₁₂; b₅=w₅+w₁₂;

a₆=w₆−w₁₁; b₆=w₆+w₁₁;

a₇=w₇−w₁₀; b₇=w₇+w₁₀;

a₈=w₈−w₉; b₈=w₈+w₉;

Turning next to the rightmost matrix in the factorization of B₂ shown in Equation (36), the following temporary variables may be defined:

t0₀=a₀−a₅−a₆;

t0₁=a₁−a₄−a₇;

t0₂=a₂−a₃−a₈;

Now taking the rightmost matrix of Equation (37), we can define one of the DCT coefficients in terms of these temporary variables:

Y₉=t0₀−t0₁−t0₂;

From Equation (38), it may be noted that it may be useful to define the interim quantity z₃=(t0₀+t0₂)·d₁₅. Two more DCT coefficients may then be expressed as:

Y₃=z₃+t0₀+t0₁;

Y₁₅=z₃+t0₂−t0₁;

Now taking the rightmost matrix of Equation (35), three new temporary variables may be defined:

tmp0₀=a₀+a₈;

tmp0₁=a₂+a₆;

tmp0₂=a₃−a₅;

From the second and third matrices on the right hand of Equation (35), we get

ttmp₀=(tmp0₀+tmp0₁)·c₄;

ttmp₁=(tmp0₂−tmp0₀)·c₁₆;

ttmp₂=(tmp0₁+tmp0₂)·c₈;

From the first matrix on the right hand of Equation (35), we get

tmp0₀=ttmp₀+ttmp₁;

tmp0₁=ttmp₀−ttmp₂;

It will be appreciated that the computation of tmp0₂ is unnecessary as we can show that tmp0₂=tmp0₁−tmp0₀.

From the rightmost matrix of Equation (33), we can define the variables:

tmp1₀=a₀−a₈;

tmp1₁=a₂−a₆;

tmp1₂=a₃+a₅;

Then from the first, second and third matrices on the right hand of Equation (33), we get:

ttmp₀=(tmp1₀−tmp1₁)·c₁₀;

ttmp₁=(tmp1₂+tmp1₁)·c₁₄;

ttmp₂=(tmp1₁+tmp1₂)·c₂;

tmp1₀=ttmp₀+ttmp₂;

tmp1₁=ttmp₁−ttmp₂;

Again, it will be appreciated that the computation of tmp1₂ is unnecessary since tmp1₂=tmp1₁+tmp1₀;

Turning now to the second matrix on the right hand of Equation (27), we can see we only need to compute temp₁=d₁₅·(a₁+a₇), as each row is either temp₁ or −temp₁.

From the first matrix on the right hand of Equation (27), we can see we only need to compute temp₂=a₁+a₄, and temp₃=a₇−a₄, as each row in the first matrix takes on one of the following 4 values: temp2, −temp2, temp3, −temp3.

We now define tmp2₀=temp₁+temp₂, and tmp2₁=temp₁+temp₃.

After applying matrix multiplication and addition, each row takes one of the following 4 values: tmp2_{0,} tmp2_{1,} −tmp2_{0,} −tmp2_{1.}

From Equations (26), (27), (32) and (34), we get

Y₁=tmp0₀+tmp1₀+tmp2₀;

Y₁₃=tmp0₁−tmp1₁−ttmp2₀;

Y₁₁=−tmp0₂+tmp1₂−tmp2_{0 =}tmp0₀+tmp1₀−(tmp0₁−tmp1₁)−tmp2₀;

Let temp₁=tmp0₀+ttmp1₀;

Let temp₂=tmp0₁−tmp1₁;

Y₁=temp₁+tmp2₀;

Y₁₃=temp₂−tmp2₀;

Y₁₁=temp₁−temp₂−tmp2₀;

We also have:

Y₅=tmp0₁+tmp1₁+tmp2₁;

Y₁₇=tmp0₀−tmp1₀−tmp2₁;

Y₇=(tmp0₁+tmp1₁₎−(ttmp0₀−tmp1₀)−tmp2_{1;}

Let temp₁=tmp0₁+tmp1₁;

Let temp₂=tmp0₀−tmp1₀;

Y₅=temp₁+tmp2₁;

Y₁₇=temp₂−ttmp2₁;

Y₇=temp₁−temp₂−tmp2_{1,}

From the bottom 4 rows of the third matrix on the right hand of Equation (17), we get:

xx₀=b₀−b₈;

xx₁=b₁−b₇;

xx2=b₂−b₆;

xx3=b₃−b₅;

From the third and fourth matrices on the right hand of Equation (22) and the third matrix on the right hand of Equation (20), we get:

tmp0₀=(xx₀+xx₃)·d₂;

ttmp0₁=(xx0+xx₂)·d₁₄;

tmp0₂=(xx₂−xx₃)·d₁₀;

From the first and second matrices on the right hand of Equation (22):

ttmp₀=tmp0₀+tmp0₂;

ttmp₁=tmp0₀−tmp0₁;

ttmp₂=tmp0₁+tmp0₂;

From the fourth row of the second matrix on the right hand of Equation (20), and also reodering in Equation (20), we realize:

Y₆=(xx₀−xx₂−xx₃)·d₆;

From the fourth column of the second matrix on the right hand of Equation (20) and reordering, we compute:

temp₁=xx₁·d₆;

From the above, the matrix multiplication and addition of the second matrix on the right hand of Equation (20), and reordering in the first matrix on the right hand of Equation (20), we get:

Y₂=ttmp₀+temp₁;

Y₁₀=ttmp₁−temp₁;

Y₁₄=ttmp₂−temp₁;

From the top 4 rows of the third matrix on the right hand of Equation (17), we get:

xx₀=b₀+b₈;

xx₁=b₁+b₇;

xx₂=b₂+b₆;

xx₃=b₃+b₅;

From the third and 4^{th} matrices of the right hand of Equation (19), we get:

tmp1₀=(xx₀−xx₂)·d₄;

tmp1₁=(xx₂−xx₃)·d₈;

tmp1₂=(xx₃−xx₀)·d₁₆;

From the 1st and 2nd matrices of the right hand of Equation (19), we get:

ttmp₀=tmp1₀+tmp1₁;

ttmp₁=tmp1₀+tmp1₂;

ttmp₂=tmp1₁−tmp1₂;

From the 4^{th} and 5^{th} column elements in the 3^{rd} and 5^{th} row of the 2^{nd} matrix of the right hand of Equation (18), we get:

temp₂=(xx₁−b₄−b₄)·\sqrt{1/2};

From the 3^{rd}, 4^{th} and 5^{th} rows of the 2^{nd} matrix of the right hand of Equation (18) and reordering in Equation (18), we get:

Y₄=ttmp₀+temp₂;

Y₈=ttmp₁−temp₂;

Y₁₆=ttmp₂−temp₂;

Let temp₁=xx₀+xx₂+xx₃;

Let temp₂=xx₁+b₄;

From the 1^{st} row of the 2^{nd} matrix on the right hand of Equation (18), and reordering, we get

Y₀=(temp₁+temp₂)·\sqrt{2};

From the 2^{nd} row of of the 2^{nd} matrix on the right hand of Equation (18), and reordering, we get:

Y₁₂=(temp₁−temp₂−temp₂)·\sqrt{1/2}.

Accordingly, we have expressions for each of the DCT coefficients Yₖ in terms of pre-calculated trigonometric values and the sample points of the interim sequence wₘ.

Based on these expressions, example pseudo code for implementing 18-point DCT is:

a₀=w₀−w₁₇; b₀=w₀+w₁₇;

a₁=w₁−w₁₆; b₁=w₁+w₁₆;

a₂=w₂−w₁₅; b₂=w₂+w₁₅;

a₃=w₃−w₁₄; b₃=w₃+w₁₄;

a₄=w₄−w₁₃; b₄=w₄+w₁₃;

a₅=w₅−w₁₂; b₅=w₅+w₁₂;

a₆=w₆−w₁₁; b₆=w₆+w₁₁;

a₇=w₇−w₁₀; b₇=w₇+w₁₀;

a₈=w₈−w₉; b₈=w₈+w₉;

t0₀=a₀−a₅−a₆;

t0₁=a₁−a₄−a₇;

t0₂=a₂−a₃−a₈;

Y₉=t0₀−t0₁−t0₂;

z=(t0₀+t0₂)·d₁₅;

Y₃=z+t0₀+t0₁;

Y₁₅=z+t0₂−t0₀;

tmp0₀=a₀+a₈;

tmp0₁=a₂+a₆;

tmp0₂=a₃−a₅;

ttmp₀=(tmp0₀+tmp0₁)·c₄;

ttmp₁=(tmp0₂−tmp0₀)·c₁₆;

ttmp₂=(tmp0₁+tmp0₂)·c₈;

tmp0₀=ttmp₀+ttmp₁;

tmp0₁=ttmp₀−ttmp₂;

tmp1₀=a₀−a₈;

tmp1₁=a₂−a₆;

tmp1₂=a₃+a₅;

ttmp₀=(tmp1₀−tmp1₁)·c₁₀;

ttmp₁=(tmp1₂+tmp1₀)·c₁₄;

ttmp₂=(tmp1₁+tmp1₂)·c₂;

tmp1₀=ttmp₀+ttmp₂;

tmp1₁=ttmp₁−ttmp₂;

temp₁=d₁₅·(a₁+a₇);

temp₂=a₁+a₄;

temp₃=a₇−a₄;

tmp2₀=temp₁+temp₂;

tmp2₁=temp₁+temp₃;

temp₁=tmp0₀+tmp1₀;

temp₂=tmp0₁−tmp1₁;

Y₁=temp₁+tmp2₀;

Y₁₃=temp₂−tmp2₀;

Y₁₁=temp₁−temp₂−tmp2₀;

temp₁=tmp0₁+tmp1₁;

temp₂=tmp0₀−tmp1₀;

Y₅=temp₁+tmp2₁;

Y₁₇=temp₂−tmp2₁;

Y₇=temp₁−temp₂−tmp2₁;

xx₀=b₀−b₈;

xx₁=b₁−b₇;

xx₂=b₂−b₆;

xx₃=b₃−b₅;

Y₆=(xx₀−xx₂−xx₃)·d₆;

tmp0₀=(xx₀+xx₃)·d₂;

tmp0₁=(xx₀+xx₂)·d₁₄;

tmp0₂=(xx₂−xx₃)·d₁₀;

tmp₀=tmp0₀+tmp0₂;

ttmp₁=tmp0₀−tmp0₁;

ttmp₂=tmp0₁+tmp0₂;

temp₁=xx₁·d₆;

Y₂=ttmp₀+temp₁;

Y₁₀=ttmp₁−temp₁;

Y₁₄=ttmp₂−temp₁;

xx₀=b₀+b₈;

xx₁=b₁+b₇;

xx₂=b₂+b₆;

xx₃=b₃+b₅;

tmp1₀=(xx₀−xx₂)·d₄;

tmp1₁=(xx₂−xx₃)·d₈;

tmp1₂=(xx₃−xx₀)·d₁₆;

ttmp₀=tmp1₀+tmp1₁

ttmp₁=tmp1₀+tmp1₂;

ttmp₂=tmp1₁−tmp1₂

temp₂=(xx₁−b₄−b₄)·\sqrt{1/2};

Y₄=ttmp₀+temp₂;

Y₈=ttmp₁−temp₂;

Y₁₆=ttmp₂−temp₂;

temp₁=xx₀+xx₂+xx₃;

temp₂=xx₁+b₄;

Y₀=(temp₁+temp₂)·\sqrt{2};

Y₁₂=(temp₁−temp₂−temp₂)·\sqrt{1/2};

As we can see, the above 18-point DCT requires 19 multiplications and 100 additions. It will be appreciated that we may obtain the MDCT coefficients Xₖ from the DCT coefficients Yₖ, as described previously.

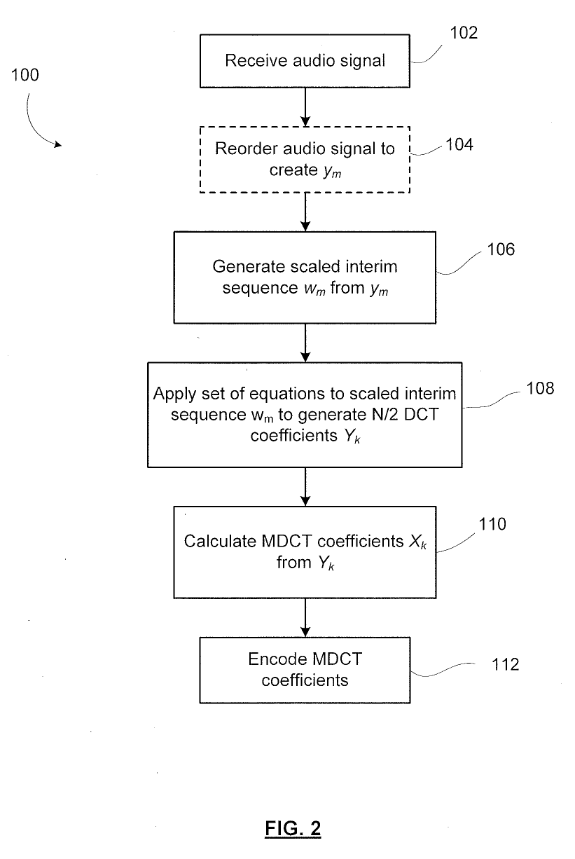

Reference is now made to FIG. 2, which shows, in flowchart form, an example method of encoding an audio input sample in accordance with the present application. Keeping in mind the foregoing discussion of example embodiments, it will be appreciated that the method 100 begins with receipt of the audio signal and, in particular, the audio signal containing input sequence xₘ in step 102. In step 104, the input sequence xₘ is reordered to create the reordered input sequence yₘ. Step 106 involves the creation of the interim sequence wₘ, from the reordered input sequence yₘ. Step 104 is shown in dashed lines to indicate that it is not necessarily present in practical implementations. It is, conceptually, inherent in the calculation of the interim sequence wₘ, directly from the input sequence xₘ. Accordingly, steps 104 and 106 may be understood to be calculation of the interim sequence wₘ from the input sequence xₘ.

In step 108, the set of equations for finding the DCT coefficients Yₖ is applied to the interim sequence wₘ. In step 110, the MDCT coefficients Xₖ are obtained from the DCT coefficients Yₖ. Following step 110, in step 112 the MDCT coefficients Xₖ are encoded. Step 112 may include quantization and entropy coding. In some embodiments, the encoding accords with MPEG Layer 3.

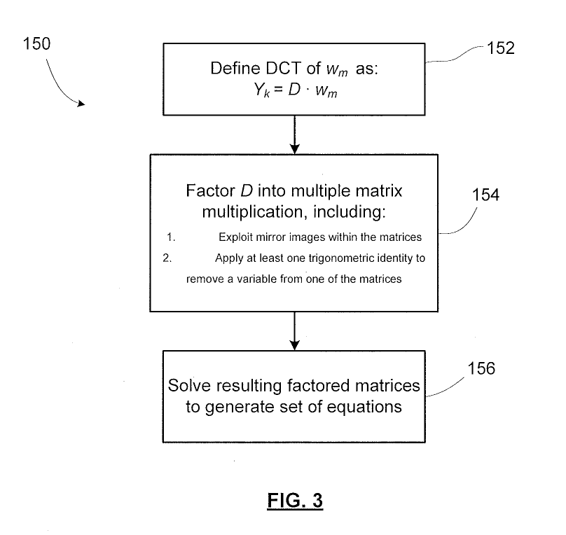

Step 108 indicates that a set of equations is to be used to find the DCT coefficients Yₖ. Reference is now made to FIG. 3, which shows a method 150 of obtaining the set of equations applied in Step 108 of the method 100 of FIG. 2.

The method 150 of FIG. 3 includes defining the DCT of the interim sequence wₘ as: Yₖ=D·wₘ in step 152. The DCT transform matrix D is then factored into a multiple matrix multiplication in step 154. The factorization includes simplifying operations such as exploiting mirror images within the matrices to further factor the expression of D, and applying at least one trigonometric identity to remove at least one variable from at least one of the matrices. As illustrated above in connection with example N=12 and example N=36, this factorization aids in simplifying the expression of the DCT transform matrix D to a degree that fewer multiplication and additions are required to implement the DCT process.

In step 156, the resulting multiplication of matrices defining the DCT coefficients Xₖ is solved to generate the set of equations.

### Inverese MDCT

The inverse MDCT may be expressed as follows:

$${\hat{x}}_{m} = {\sum }_{k = 0}^{N / 2 - 1} {X}_{k} \cdot cos [ \frac{π}{2 N} ( 2 k + 1 ) ( 2 m + 1 + \frac{N}{2} ) ] , \\ m = 0 , 1 , … , N - 1. \qquad ( 39 )$$

It may be shown that the inverse MDCT has the following properties:

$$\begin{matrix}{\hat{x}}_{\frac{N}{2} - 1 - m} = - {\hat{x}}_{m} , \\ m = 0 , … \frac{N}{2} - 1 ; & 1 ) \\ {\hat{x}}_{\frac{N}{2} + m} = - {\hat{x}}_{N - 1 - m} , \\ m = 0 , … \frac{N}{4} - 1. & 2 )\end{matrix}$$

Therefore we only need to compute inverse MDCT for N/2 points:

Define t=m−(N/4), N/4≦m≦(3N/4)−1, 0≦t≦(N/2)−1.

Define:

$${\tilde{x}}_{t} = {\sum }_{k = 0}^{N / 2 - 1} {X}_{k} \cdot cos [ \frac{π}{2 N} ( 2 k + 1 ) ( 2 t + 1 ) ] , \\ t = 0 , 1 , … , N - 1. \qquad ( 40 )$$

We have

$${\hat{x}}_{\frac{N}{2} + t} = {\tilde{x}}_{t} .$$

It will be appreciated that Equation (40) is similar to Equation (4). Therefore, following a similar approach as described above in connection with the forward MDCT, we may obtain a fast algorithm for inverse MDCT. Note that the N/2 additions in Equation (4) does not exist in the inverse MDCT.

### Complexity Analysis

Equation (6) involves N/2 multiplications and additions. Equation (7) involves N/2−1 multiplications. Based on the embodiments described above, the total number of multiplications and additions for 12-point forward MDCT is 10 and 29 respectively. The total number of multiplications and additions for 36-point forward MDCT are 37 and 135 respectively.

Table 1 below gives a comparison of the computational complexity of the proposed fast MDCT process described above, for the 12-point and 36-point embodiments and two known processes. The two known processes are. Lee's algorithm described in S.-W. Lee, “Improved algorithm for efficient computation of the forward and backward MDCT in MPEG audio coder”, IEEE Transactions on Circuits and Systems-II: Analog and Digital Signal Processing, Vol. 48, No. 10, pp. 990-994, October 2000, and Britanak's algorithm described in V. Britanak and K. R. Rao, “An efficient implementation of the forward and inverse MDCT in MPEG Audio Coding”, IEEE Signal Processing Letters, Vol. 8, No. 2, pp. 48-51, February 2001; and V. Britanak and K. R. Rao, “A new fast algorithm for the unified forward and inverse MDCT/MDST computation”, Signal Processing Letters, Vol. 82, pp. 433-459, 2002. It will be appreciated that the proposed algorithm has lower computational complexity for both forward and inverse MDCT.

TABLE 1
Complexity comparison

| Total number of | | |
|---|---|---|
| Multiplication/ | Length N = 12 | Length N = 36 |
| Addition | Multiplication/Addition | Multiplication/Addition |
| Britanik's | 13/39 - Forward MDCT | 47/165 - Forward MDCT |
| algorithm [6] | 13/33 - Inverse MDCT | 47/151 - Inverse MDCT |
| Lee's algorithm [5] | 11/29 - Forward MDCT | 43/133 - Forward MDCT |
| | 11/23 - Inverse MDCT | 43/115 - Inverse MDCT |
| The proposed | 10/29 - Forward MDCT | 37/135 - Forward MDCT |
| algorithm | 10/23 - Inverse MDCT | 37/117 - Inverse MDCT |

### Windowing

In some embodiments, the multiplication coefficient

$$\frac{1}{2 \sqrt{2} cos ( \frac{π}{N} \frac{2 m + 1}{2} )}$$

in Equation (8) can be merged into the windowing step of MP3 audio coding. Along with windowing, the forward MDCT could be expressed as

$${X}_{k} = {\sum }_{m = 0}^{N - 1} {x}_{m} \cdot {v}_{m} cos [ \frac{π}{2 N} ( 2 k + 1 ) ( 2 m + 1 + \frac{N}{2} ) ] , \\ k = 0 , 1 , … \frac{N}{2} - 1 \qquad ( 41 )$$

where vₘ is a windowing sequence with a length N for the input sequence xₘ. It will be appreciated that the multiplication coefficient

$$\frac{1}{2 \sqrt{2} cos ( \frac{π}{N} \frac{2 m + 1}{2} )}$$

could be pre-multiplied with vₘ to form a scaled windowing sequence, which removes N/2 multiplications in MDCT. Therefore, the total number of multiplications in 12-point MDCT and inverse MDCT for the proposed algorithm is reduced to 4, and the total number of multiplications in 36-point MDCT and inverse MDCT for the proposed algorithm is reduced to 19.

It will be understood that the calculation of the interim sequence wₘ directly from the input sequence xₘ, will make the values of wₘ dependent upon two values of the input sequence xₘ. For example, for N=12, if the values xₘ are pre-scaled by the multiplication coefficient, then we get the following relations:

w₀=−x₉−x₈;

w₁=−x₁₀−x₇;

w₂=−x₁₁−x₆;

w₃=x₀−x₅;

w₄=x₁−x₄;

w₅=x₂−x₃;

To extract the multiplication coefficient from the calculation of wₘ and perform it during the windowing operation, it will be appreciated that the multiplication coefficient applied to each element of xₘ at the windowing stage will need to reflect the index of the interim sequence for which that element is going to be used. For example, elements x₉ and x₈ are scaled by the multiplication coefficient with m=0 in the denominator.

As can be seen from the foregoing, the interim sequence is defined as a scaled sequence of length N/2 where each element is based on the difference between two of the elements in the input sequence. The scaling is then extracted from the calculation of the interim sequence and applied directly to the elements of the input sequence during the windowing operation to substantially reduce the number of multiplications required. This improvement is equally applicable to other N/2 DCT-based fast MDCT processes, such as that disclosed by Lee in S.-W. Lee, “Improved algorithm for efficient computation of the forward and backward MDCT in MPEG audio coder”, IEEE Transactions on Circuits and Systems-II: Analog and Digital Signal Processing, Vol. 48, No. 10, pp. 990-994, October 2000.

The foregoing description presents various methods and processes for developing a set of equations or calculations for realizing MDCT coefficients from an input sequence by factoring a matrix-based expression of a DCT transform matrix. It will be appreciated that the resulting set of MDCT equations (or inverse MDCT equations) may be used in transforming any input sequence into the MDCT spectral coefficients (or vice versa). It is particularly applicable to transforming audio input sequences in an encoding/compression or decoding/decompression process. It will also be appreciated that the process may be implemented on any suitably programmed general purpose computer, processor, ASIC, digital signal processor (DSP), etc. The programming of such a device to apply the set of equations to an input sequence will be within the understanding of a person of ordinary skill in the art having regard to the foregoing description.

By way of example, reference is now made to FIG. 4, which shows an example embodiment of an encoder 200. The encoder 200 may include a processor 202 and memory 204. The memory 204 may have stored therein an audio encoding module 206 executable by the processor 202 and containing program instructions suitable for configuring the processor 202 to perform one or more of the encoding processes described herein. The encoder 200 may include an input port 208 or other suitable communications interface for receiving input audio data and outputting encoded data.

Certain adaptations and modifications of the described embodiments can be made. Therefore, the above discussed embodiments are considered to be illustrative and not restrictive.

What is claimed is:

1. A method of encoding an audio signal using a modified discrete cosine transform (MDCT), the method comprising:
receiving the audio signal, the audio signal including an input sequence of length N;
calculating a scaled interim sequence as a function of the input sequence;
calculating an output sequence of discrete cosine transform (DCT) coefficients by performing an N/2-point DCT of the scaled interim sequence by applying to the scaled interim sequence a set of equations derived by factoring a DCT transform matrix into a multiplication of at least three matrices and performing at least one simplifying operation;
calculating the MDCT coefficients of the input sequence from the DCT coefficients; and
encoding the MDCT coefficients.

2. The method claimed in claim 1, wherein performing at least one simplifying operation includes factoring one of the at least three matrices based on at least one mirror image of elements within the one of the at least three matrices.

3. The method claimed in claim 1, wherein performing at least one simplifying operation includes eliminating a variable from elements within one of the at least three matrices using at least one trigonometric identity.

4. The method claimed in claim 1, wherein factoring includes factoring a submatrix within one of the at least three matrices.

5. The method claimed in claim 1, wherein the encoding comprises MPEG Layer 3 encoding.

6. The method claimed in claim 1, further including applying a window sequence to the input sequence in a windowing operation prior to calculating the scaled interim sequence, and wherein each element of the scaled interim sequence is calculated as a difference between two elements of the input sequence multiplied by an indexed coefficient, and wherein the multiplication of the indexed coefficient is incorporated into the window sequence and applied during the windowing operation.

7. The method claimed in claim 1, wherein the input sequence comprises xₘ, m=0, 1, . . . ,N−1;
wherein a reordered input sequence yₘ, m=0,1, . . . ,N−1, comprises:
$${y}_{m} = \{ \begin{matrix}- {x}_{m + ( 3 N / 4 ) , m = 0 , 1 , … , \frac{N}{4} - 1} \\ {x}_{m - ( N / 4 ) , m = \frac{N}{4} , \frac{N}{4} + 1 , … N - 1}\end{matrix}$$
wherein the scaled interim sequence wₘ, m=0,1, . . . , N/2−1, comprises:
$${w}_{m} = ( {y}_{m} - {y}_{N - 1 - m} ) \frac{1}{2 \sqrt{2} cos ( \frac{π}{N} \frac{2 m + 1}{2} )}$$
wherein the N/2-point DCT coefficients Yₖ of the scaled interim sequence comprise:
$${Y}_{k} = {\sum }_{m = 0}^{N / 2 - 1} {w}_{m} \sqrt{2 } cos [ \frac{π}{N} k ( 2 m + 1 ) ] , \\ k = 0 , 1 , … \frac{N}{2} - 1 ;$$
and wherein the MDCT coefficients Xₖ comprise:
Xₖ=Yₖ+Yₖ₊₁.

8. The method claimed in claim 7, wherein N=12 and the set of equations comprise:
Y₀=\sqrt{2}·(z₁+a₁),
Y₁=z₂+a₄+a₅,
Y₂=d₂−(a₀−a₂),
Y₃=a₅−a₄−a₃,
Y₄=\sqrt{1/2}·(z₁−a₁−a₁),
Y₅=z₂+a₃−a₄,
in which a₀=w₀+w₅, a₅=w₀−w₅, a₁=w₁+w₄, a₄=w₁−w₄, a₂=w₂+w₃, a₃=w₂−w₃, z₁=a₀+a₂; and z₂=d₅·(a₃+a₅), and
$${d}_{k} = \sqrt{2} cos ( \frac{k}{12} π ) .$$

9. The method claimed in claim 7, wherein N=36 and the set of equations comprise:
a₀=w₀−w₁₇; b₀=w₀+w₁₇;
a₁=w₁−w₁₆; b₁=w₁+w₁₆;
a₂=w₂−w₁₅; b₂=w₂+w₁₅;
a₃=w₃−w₁₄; b₃=w₃+w₁₄;
a₄=w₄−w₁₃; b₄=w₄+w₁₃;
a₅=w₅−w₁₂; b₅=w₅+w₁₂;
a₆=w₆−w₁₁; b₆=w₆+w₁₁;
a₇=w₇−w₁₀; b₇=w₇+w₁₀;
a₈=w₈−w₉; b₈=w₈+w₉;
t0₀=a₀−a₅−a₆;
t0₁=a₁−a₄−a₇;
t0₂=a₂−a₃−a₈;
Y₉=t0₀−t0₁−t0₂;
z=(t0₀+t0₂)·d₁₅;
Y₃=z+t0₀+t0₁;
Y₁₅=z+t0₂−t0₁;
tmp0₀=a₀+a₈;
tmp0₁=a₂+a₆;
tmp0₂=a₃−a₅;
ttmp₀=(tmp0₀+tmp0₁)·c₄;
ttmp₁=(tmp0₂−tmp0₀)·c₁₆;
ttmp₂=(tmp0₁+tmp0₂)·c₈;
tmp0₀=ttmp₀+ttmp₁;
tmp0₁=ttmp₀−ttmp₂;
tmp1₀=a₀−a₈;
tmp1₁=a₂−a₆;
tmp1₂=a₃+a₅;
ttmp₀=(tmp1₀−tmp1₁)·c₁₀;
ttmp₁=(tmp1₂+tmp1₀)·c₁₄;
ttmp₂=(tmp1₁+tmp1₂)·c₂;
tmp1₀=ttmp₀+ttmp₂;
tmp1₁=ttmp₁−ttmp₂;
temp₁=d₁₅·(a₁+a₇);
temp₂=a₁+a₄;
temp₃=a₇−a₄;
tmp2₀=temp₁+temp₂;
tmp2₁=temp₁+temp₃;
temp₁=tmp0₀+tmp1₀;
temp₂=tmp0₁−tmp1₁;
Y₁=temp₁+tmp2₀;
Y₁₃=temp₂−tmp2₀;
Y₁₁=temp₁−temp₂−tmp2₀;
temp₁=tmp0₁+tmp1₁;
temp₂=tmp0₀−tmp1₀;
Y₅=temp1+tmp2₁;
Y₁₇=temp₂−tmp2₁;
Y₇=temp₁−temp₂−tmp2₁;
xx₀=b₀−b₈;
xx₁=b₁−b₇;
xx₂=b₂−b₆;
xx₃=b₃−b₅;
Y₆=(xx₀−xx₂−xx₃)·d₆;
tmp0₀=(xx₀+xx₃)·d₂;
tmp0₁=(xx₀+xx₂)·d₁₄;
tmp0₂=(xx₂−xx₃)·d₁₀;
tmp₀=tmp0₀+tmp0₂;
ttmp₁=tmp0₀−tmp0₁;
ttmp₂=tmp0₁+tmp0₂;
temp₁=xx₁·d₆;
Y₂=ttmp₀+temp₁;
Y₁₀=ttmp₁−temp₁;
Y₁₄=ttmp₂−temp₁;
xx₀=b₀+b₈;
xx₁=b₁+b₇;
xx₂=b₂+b₆;
xx₃=b₃+b₅;
tmp1₀=(xx₀−xx₂)·d₄;
tmp1₁=(xx₂−xx₃)·d₈;
tmp1₂=(xx₃−xx₀)·d₁₆;
ttmp₀=tmp1₀+tmp1₁
ttmp₁=tmp1₀+tmp1₂;
ttmp₂=tmp1₁−tmp1₂
temp₂=(xx₁−b₄−b₄)·\sqrt{1/2};
Y₄=ttmp₀+temp₂;
Y₈=ttmp₁−temp₂;
Y₁₆=ttmp₂−temp₂;
temp₁=xx₀+xx₂+xx₃;
temp₂=xx₁+b₄;
Y₀=(temp₁+temp₂)·\sqrt{2};
Y₁₂=(temp₁−temp₂−temp₂)·\sqrt{1/2},
wherein
$${d}_{k} = \sqrt{2} cos ( \frac{k}{12} π ) and {c}_{k} = cos ( \frac{k}{36} π ) .$$

10. An encoder for encoding an audio signal using a modified discrete cosine transform (MDCT), the encoder comprising:
a processor;
memory;
an input port for receiving the audio signal, the audio signal including an input sequence of length N; and
an audio encoding module stored in memory and containing instructions for configuring the processor to
define a scaled interim sequence as a function of the input sequence,
calculate an output sequence of discrete cosine transform (DCT) coefficients by performing an N/2-point DCT of the scaled interim sequence by applying to the scaled interim sequence a set of equations derived by factoring a DCT transform matrix into a multiplication of at least three matrices and performing at least one simplifying operation,
calculate the MDCT coefficients of the input sequence from the DCT coefficients, and
encode the MDCT coefficients.

11. The encoder claimed in claim 10, wherein performing at least one simplifying operation includes factoring one of the at least three matrices based on at least one mirror image of elements within the one of the at least three matrices.

12. The encoder claimed in claim 10, wherein performing at least one simplifying operation includes eliminating a variable from elements within one of the at least three matrices using at least one trigonometric identity.

13. The encoder claimed in claim 10, wherein factoring includes factoring a submatrix within one of the at least three matrices.

14. The encoder claimed in claim 10, wherein the module comprises an MPEG Layer 3 encoder module and the instructions configure the processor to implement MPEG Layer 3 compliant encoding of the audio signal.

15. The encoder claimed in claim 10, wherein the audio encoding module is further configured to apply a window sequence to the input sequence in a windowing operation prior to calculating the scaled interim sequence, and wherein each element of the scaled interim sequence is calculated as a difference between two elements of the input sequence multiplied by an indexed coefficient, and wherein the multiplication of the indexed coefficient is incorporated into the window sequence and applied during the windowing operation.

16. The encoder claimed in claim 10, wherein the input sequence comprises xₘ, m=0,1, . . . , N−1;
wherein a reordered input sequence yₘ, m=0,1, . . . ,N−1, comprises:
$${y}_{m} = \{ \begin{matrix}- {x}_{m + ( 3 N / 4 ) ; m = 0 , 1 , … , \frac{N}{4} - 1} \\ {x}_{m - ( N / 4 ) , m = \frac{N}{4} , \frac{N}{4} + 1 , … N - 1}\end{matrix}$$
wherein the scaled interim sequence wₘ, m=0,1, . . . , N/2−1, comprises:
$${w}_{m} = ( {y}_{m} - {y}_{N - 1 - m} ) \frac{1}{2 \sqrt{2} cos ( \frac{π}{N} \frac{2 m + 1}{2} )}$$
wherein the N/2-point DCT coefficients Yₖ of the scaled interim sequence comprise:
$${Y}_{k} = {\sum }_{m = 0}^{N / 2 - 1} {w}_{m} \sqrt{2 } cos [ \frac{π}{N} k ( 2 m + 1 ) ] , \\ k = 0 , 1 , … \frac{N}{2} - 1 ;$$
and wherein the MDCT coefficients Xₖ comprise:
Xₖ=Yₖ+Yₖ₊₁.

17. The encoder claimed in claim 16, wherein N=12 and the set of equations comprises:
Y₀=\sqrt{2}·(z₁+a₁),
Y₁=z₂+a₄+a₅,
Y₂=d₂·(a₀−a₂),
Y₃=a₅−a₄−a₃,
Y₄=\sqrt{1/2}·(z₁−a₁−a₁),
Y₅=z₂+a₃−a₄,
in which a₀=w₀+w₅, a₅−w₀−w₅, a₁=w₁+w₄, a₄=w₁−w₄, a₂=w₂+w₃, a₃=w₂−w₃, z₁=a₀+a₂; and z₂=d₅·(a₃+a₅), and
$${d}_{k} = \sqrt{2} cos ( \frac{k}{12} π ) .$$

18. The encoder claimed in claim 16, wherein N=36 and the set of equations comprises:
a₀=w₀−w₁₇; b₀=w₀+w₁₇;
a₁=w₁−w₁₆; b₁=w₁+w₁₆;
a₂=w₂−w₁₅; b₂=w₂+w₁₅;
a₃=w₃−w₁₄; b₃=w₃+w₁₄;
a₄=w₄−w₁₃; b₄=w₄+w₁₃;
a₅=w₅−w₁₂; b₅=w₅+w₁₂;
a₆=w₆−w₁₁; b₆=w₆+w₁₁;
a₇=w₇−w₁₀; b₇=w₇+w₁₀;
a₈=w₈−w₉; b₈=w₈+w₉;
t0₀=a₀−a₅−a₆;
t0₁=a₁−a₄−a₇;
t0₂=a₂−a₃−a₈;
Y₉=t0₀−t0₁−t0₂;
z=(t0₀+t0₂)·d₁₅;
Y₃=z+t0₀+t0₁;
Y₁₅=z+t0₂−t0₁;
tmp0₀=a₀+a₈;
tmp0₁=a₂+a₆;
tmp0₂=a₃−a₅;
ttmp₀=(tmp0₀+tmp0₁)·c₄;
ttmp₁=(tmp0₂−tmp0₀)·c₁₆;
ttmp₂=(tmp0₁+tmp0₂)·c₈;
tmp0₀=ttmp₀+ttmp₁;
tmp0₁=ttmp₀−ttmp₂;
tmp1₀=a₀−a₈;
tmp1₁=a₂−a₆;
tmp1₂=a₃+a₅;
ttmp₀=(tmp1₀−tmp1₁)·c₁₀;
ttmp₁=(tmp1₂+tmp1₀)·c₁₄;
ttmp₂=(tmp1₁+tmp1₂)·c₂;
tmp1₀=ttmp₀+ttmp₂;
tmp1₁=ttmp₁−ttmp₂;
temp₁=d₁₅·(a₁+a₇);
temp₂=a₁+a₄;
temp₃=a₇−a₄;
tmp2₀=temp₁+temp₂;
tmp2₁=temp₁+temp₃;
temp₁=tmp0₀+tmp1₀;
temp₂=tmp0₁−tmp1₁;
Y₁=temp₁+tmp2₀;
Y₁₃=temp₂−tmp2₀;
Y₁₁=temp₁−temp₂−tmp2₀;
temp₁=tmp0₁+tmp1₁;
temp₂=tmp0₀−tmp1₀;
Y₅=temp1+tmp2₁;
Y₁₇=temp₂−tmp2₁;
Y₇=temp₁−temp₂−tmp2₁;
xx₀=b₀−b₈;
xx₁=b₁−b₇;
xx₂=b₂−b₆;
xx₃=b₃−b₅;
Y₆=(xx₀−xx₂−xx₃)·d₆;
tmp0₀=(xx₀+xx₃)·d₂;
tmp0₁=(xx₀+xx₂)·d₁₄;
tmp0₂=(xx₂−xx₃)·d₁₀;
tmp₀=tmp0₀+tmp0₂;
ttmp₁=tmp0₀−tmp0₁;
ttmp₂=tmp0₁+tmp0₂;
temp₁=xx₁·d₆;
Y₂=ttmp₀+temp₁;
Y₁₀=ttmp₁−temp₁;
Y₁₄=ttmp₂−temp₁;
xx₀=b₀+b₈;
xx₁=b₁+b₇;
xx₂=b₂+b₆;
xx₃=b₃+b₅;
tmp1₀=(xx₀−xx₂)·d₄;
tmp1₁=(xx₂−xx₃)·d₈;
tmp1₂=(xx₃−xx₀)·d₁₆;
ttmp₀=tmp1₀+tmp1₁
ttmp₁=tmp1₀+tmp1₂;
ttmp₂=tmp1₁−tmp1₂
temp₂=(xx₁−b₄−b₄)·\sqrt{1/2};
Y₄=ttmp₀+temp₂;
Y₈=ttmp₁−temp₂;
Y₁₆=ttmp₂−temp₂;
temp₁=xx₀+xx₂+xx₃;
temp₂=xx₁+b₄;
Y₀=(temp₁+temp₂)·\sqrt{2};
Y₁₂=(temp₁−temp₂−temp₂)·\sqrt{1/2},
wherein
$${d}_{k} = \sqrt{2} cos ( \frac{k}{12} π ) and {c}_{k} = cos ( \frac{k}{36} π ) .$$

19. A method of encoding an audio signal using a 12-point modified discrete cosine transform (MDCT), the method comprising:
receiving the audio signal, the audio signal including a data sequence xₘ, m=0,1, . . . ,11;
calculating a sequence of DCT coefficients Yₖ as a 6-point DCT of a transformed sequence wₘ derived from the data sequence xₘ, in which the transformed sequence wₘ is defined as
$${w}_{m} = ( {y}_{m} - {y}_{N - 1 - m} ) \frac{1}{2 \sqrt{2} cos ( \frac{π}{N} \frac{2 m + 1}{2} )} , \\ m = 0 , 1 , … , 5 ,$$
and in which a reordered input sequence y is defined as
$${y}_{m} = \{ \begin{matrix}- {x}_{m + 9 , m = 0 , 1 , 2} \\ {x}_{m - 3 , m = 3 , 4 , … , 11}\end{matrix}$$
calculating the MDCT coefficients Xₖ of the data sequence xₘ from the DCT coefficients Yₖ based on the relation Xₖ=Yₖ+Yₖ₊₁, k=0,1, . . . ,5; and
encoding the MDCT coefficients Xₖ,
wherein calculating the sequence of DCT coefficients includes determining the DCT coefficients in accordance with the following expressions,
Y₀=\sqrt{2}·(z₁+a₁),
Y₁=z₂+a₄+a₅,
Y₂=d₂(a₀−a₂),
Y₃=a₅−a₄−a₃,
Y₄=\sqrt{1/2}·(z₁−a₁−a₁),
Y₅=z₂+a₃−a₄,
in which a₀=w₀+w₅, a₅=w₀−w₅, a₁=w₁+w₄, a₄=w₁−w₄, a₂=w₂+w₃, a₃=w₂−w₃, z₁=a₀+a₂; and z₂=d₅·(a₃+a₅).

20. A method of encoding an audio signal using a modified discrete cosine transform (MDCT), the method comprising:
receiving the audio signal, the audio signal including a data sequence;
multiplying the data sequence by a windowing sequence to create a windowed data sequence of length N;
calculating a scaled interim sequence of length N/2 as a function of the windowed data sequence;
performing an N/2-point DCT of the scaled interim sequence to create an output sequence of DCT coefficients;
calculating the MDCT coefficients of the data sequence from the DCT coefficients; and
encoding the MDCT coefficients,
wherein the each element of the scaled interim sequence is a difference between two elements of the data sequence multiplied by an indexed coefficient, and wherein the indexed coefficient is incorporated into the window sequence and applied when multiplying the data sequence by the windowing sequence.

21. The method claimed in claim 20, wherein the scaled interim sequence wₘ is defined as:
$${w}_{m} = ( {y}_{m} - {y}_{N - 1 - m} ) \frac{1}{2 \sqrt{2} cos ( \frac{π}{N} \frac{2 m + 1}{2} )} , \\ m = 0 , 1 , … N / 2 - 1 ,$$
and wherein
$${y}_{m} = \{ \begin{matrix}- {x}_{m + ( 3 N / 4 ) , m = 0 , 1 , … , \frac{N}{4} - 1} \\ {x}_{m - ( N / 4 ) , m = \frac{N}{4} , \frac{N}{4} + 1 , … N - 1}\end{matrix} ,$$
and wherein xₘ comprises the data sequence.

22. The method claimed in claim 20, wherein multiplying the data sequence by the windowing sequence comprises multiplying the data sequence by the windowing sequence element-by-element, and wherein each element of the windowing sequence incorporates the indexed coefficient.
